(19) United States
(12) Patent Application Publication
(10) Pub. No.: US 2023/0029850 A1
(43) Pub. Date: Feb. 2, 2023

(54) METHOD AND APPARATUS FOR REPEATEDLY TRANSMITTING UPLINK DATA FOR NETWORK COOPERATIVE COMMUNICATION

(71) Applicant: Samsung Electronics Co., Ltd., Gyeonggi-do (KR)

(72) Inventors: Jinhyun PARK, Gyeonggi-do (KR); Hoondong NOH, Gyeonggi-do (KR); Youngrok JANG, Gyeonggi-do (KR)

(21) Appl. No.: 17/783,146

(22) PCT Filed: Dec. 24, 2020
(86) PCT No.: PCT/KR2020/019144

§ 371 Date: Jun. 7, 2022

(30) Foreign Application Priority Data
Dec. 27, 2019 (KR) 10-2019-0176535

(51) Int. Cl. H04L 1/00; H04L 1/08; H04W 72/12

(52) U.S. Cl. CPC H04L 1/0063; H04L 1/08; H04W 72/1268; H04W 72/1278

(57) ABSTRACT

The disclosure relates to a communication technique and system therefor for converging an Internet of Things (IoT) technology and a 5^{th} generation (5G) communication system for supporting a high data rate after a 4^{th} generation (4G) system. The disclosure is applicable to intelligent services (e.g., smart home, smart building, smart city, smart car or connected car, health care, digital education, retail, security, and safety services) based on a 5G communication technology and IoT-related technology. The disclosure provides a method and apparatus for uplink (UL) data repetition transmission by a user equipment (UE) in a next-generation communication system.

### TECHNICAL FIELD

The disclosure relates to a wireless communication system, and more particularly, to an uplink (UL) data repetition transmission method and apparatus for a base station (BS) to seamlessly receive control information and data transmitted by a user equipment (UE).

### BACKGROUND ART

In order to meet significantly increasing demand with respect to wireless data traffic due to the commercialization of 4^{th} generation (4G) communication systems and the increase in multimedia services, evolved 5^{th} generation (5G) system or pre-5G communication system are developed. For this reason, 5G or pre-5G communication systems are called ‘beyond 4G network’ communication systems or ‘post long term evolution (post-LTE)’ systems.

In order to increase a data rate, implementation of 5G communication systems in an ultra-high frequency or millimeter-wave (mmWave) band (e.g., a 60 GHz band) is being considered. In order to reduce path loss of radio waves and increase a transmission distance of radio waves in the ultra-high frequency band for 5G communication systems, various technologies such as beamforming, massive multiple-input and multiple-output (massive MIMO), full-dimension MIMO (FD-MIMO), array antennas, analog beamforming, and large-scale antennas are being studied.

Furthermore, to improve network functions for 5G communication systems, various technologies such as evolved small cells, advanced small cells, cloud Radio Access Networks (Cloud-RAN), ultra-dense networks, Device-To-Device communication (D2D), wireless backhaul, moving networks, cooperative communication, Coordinated Multi-Points (CoMP), received-interference cancellation, or the like have been developed. In addition, for 5G communication systems, advanced coding modulation (ACM) technologies such as hybrid frequency-shift keying (FSK) and quadrature amplitude modulation (QAM) (FQAM) and sliding window superposition coding (SWSC), and advanced access technologies such as filter bank multi-carrier (FBMC), non-orthogonal multiple access (NOMA), sparse code multiple access (SCMA), or the like have been developed.

The Internet has evolved from a human-based connection network, where humans create and consume information, to the Internet of things (IoT), where distributed elements such as objects exchange information with each other to process the information. Internet of everything (IoE) technology has emerged, in which the IoT technology is combined with, for example, technology for processing big data through connection with a cloud server. In order to implement the IoT, various technological elements such as sensing technology, wired/wireless communication and network infrastructures, service interface technology, and security technology are required, such that, in recent years, technologies related to sensor networks for connecting objects, Machine-To-Machine (M2M) communication, and Machine-Type Communication (MTC) have been studied. In the IoT environment, intelligent Internet technology (IT) services may be provided to collect and analyze data obtained from connected objects to create new value in human life. As existing information technology (IT) and various industries converge and combine with each other, the IoT may be applied to various fields such as smart homes, smart buildings, smart cities, smart cars or connected cars, smart grids, health care, smart home appliances, and advanced medical services.

Various attempts are being made to apply 5G communication systems to the IoT network. For example, 5G communication technologies such as sensor networks, M2M communication, MTC, or the like are being implemented by using techniques including beamforming, MIMO, array antennas, or the like. Application of Cloud-RAN as the above-described big data processing technology may be an example of convergence of 5G communication technology and IoT technology.

Because various services may be provided due to the aforementioned technical features and the development of wireless communication systems, in particular, methods for seamlessly supporting a service related to uplink (UL) data repetition transmission by a user equipment (UE) are required.

### DESCRIPTION OF EMBODIMENTS

### Solution to Problem

The disclosure may provide a method and apparatus for uplink (UL) data repetition transmission by a user equipment (UE) in a wireless communication system.

### Advantageous Effects of Disclosure

According to the disclosure, reception reliability of a base station (BS) when a user equipment (UE) repeatedly transmits uplink (UL) data may be improved.

### BRIEF DESCRIPTION OF DRAWINGS

FIG. 1 is a diagram illustrating a basic structure of a time-frequency domain of a wireless communication according to an embodiment of the disclosure.

FIG. 2 is a diagram illustrating structures of a frame, a subframe, and a slot in a next-generation wireless communication system according to an embodiment of the disclosure.

FIG. 3 is a diagram illustrating an example of configuration of bandwidth parts (BWPs) in a wireless communication system according to an embodiment of the disclosure.

FIG. 4 is a diagram for describing control resource set configuration of a downlink (DL) control channel of a next-generation wireless communication system according to an embodiment of the disclosure.

FIG. 5 is a diagram for describing a structure of a DL control channel of the next-generation wireless communication system according to an embodiment of the disclosure.

FIG. 6 is a diagram illustrating an example of physical downlink shared channel (PDSCH) frequency-domain resource allocation in a wireless communication system according to an embodiment of the disclosure.

FIG. 7 is a diagram illustrating an example of PDSCH time-domain resource allocation in a wireless communication system according to an embodiment of the disclosure.

FIG. 8 is a diagram illustrating an example of time-domain resource allocation based on subcarrier spacings (SCSs) of a data channel and a control channel in a wireless communication system according to an embodiment of the disclosure.

FIG. 9 is a diagram illustrating an example of PUCCH resource allocation for hybrid automatic repeat request (HARQ)-acknowledgement (ACK) feedback according to some embodiments.

FIG. 10 is a diagram illustrating protocol stacks of a base station (BS) and a user equipment (UE) in performing of a single cell, carrier aggregation and dual connectivity according to some embodiments.

FIG. 11 is a diagram illustrating antenna port configuration and resource allocation for cooperative communication in a wireless communication system according to an embodiment of the disclosure.

FIG. 12 is a diagram illustrating an example of configuration of downlink control information (DCI) for cooperative communication in a wireless communication system according to an embodiment of the disclosure.

FIG. 13 is a diagram illustrating an example of repetition transmission by multiple transmission and reception points (TRPs) to which various resource allocation methods are applied in a wireless communication system according to an embodiment of the disclosure.

FIG. 14 is a flowchart illustrating BS operations in a wireless communication system according to an embodiment of the disclosure.

FIG. 15 is a flowchart illustrating UE operations in a wireless communication system according to an embodiment of the disclosure.

FIG. 16 is a diagram illustrating a structure of a UE in a wireless communication according to an embodiment of the disclosure.

FIG. 17 is a diagram illustrating a structure of a BS in a wireless communication system according to an embodiment of the disclosure.

### BEST MODE

According to an embodiment of the disclosure, a method performed by a base station (BS) in a wireless communication system may include: receiving, from a user equipment (UE), a capability report on physical uplink shared channel (PUSCH) repetition transmissions via at least one of a plurality of transmission points, a plurality of panels, or a plurality of beams; transmitting, to the UE, configuration information about PUSCH repetition transmissions via at least one of the plurality of transmission points, the plurality of panels, or the plurality of beams; transmitting, to the UE, information indicating the PUSCH repetition transmissions; receiving repetitive PUSCHs from the UE; and decoding the received repetitive PUSCHs, based on the configuration information about the PUSCH repetition transmissions.

According to an embodiment of the disclosure, a method performed by a UE in a wireless communication system may include: transmitting, to a BS, a capability report on PUSCH repetition transmissions via at least one of a plurality of transmission points, a plurality of panels, or a plurality of beams; receiving, from the BS, configuration information about PUSCH repetition transmissions via at least one of the plurality of transmission points, the plurality of panels, or the plurality of beams; receiving, from the BS, information indicating the PUSCH repetition transmissions; encoding repetitive PUSCHs based on the configuration information about the PUSCH repetition transmissions; and transmitting the encoded repetitive PUSCHs to the BS.

According to an embodiment of the disclosure, a UE for transmitting or receiving a signal in a wireless communication system may include a transceiver, and at least one processor. The at least one processor may be configured to receive, from a BS, configuration information for repeatedly transmitting a PUSCH to a plurality of transmission and reception points (TRPs), determine at least one of a transport block size and a low-density parity-check base graph (LDPC BG) for repetition transmission of the PUSCH, based on the configuration information for repeatedly transmitting the PUSCH to the plurality of TRPs, encode a plurality of PUSCHs to be repeatedly transmitted to the plurality of TRPs, based on at least one of the transport block size and the LDPC BG, and transmit the plurality of encoded PUSCHs to the plurality of TRPs, respectively.

In an embodiment, the at least one processor may be further configured to receive, from the BS, configuration information including information about a plurality of sounding reference signal (SRS) resource sets for transmission of an SRS to the plurality of TRPs. The plurality of SRS resource sets may respectively correspond to different TRPs among the plurality of TRPs.

In an embodiment, the plurality of encoded PUSCHs may be transmitted to the plurality of TRPs, wherein at least one of a time resource, a frequency resource, or a spatial resource for the plurality of encoded PUSCHs differs.

In an embodiment, the at least one processor may be further configured to determine representative information based on at least one of a plurality of pieces of configuration information respectively for the plurality of TRPs, from the configuration information for repeatedly transmitting the PUSCH to the plurality of the TRPs, and determine, based on the representative information, at least one of the transport block size and the LDPC BG for repetition transmission of the PUSCH.

In an embodiment, the representative information may be determined based on at least one of power information, transmission beam information, transmission precoder information, and scheduling information which are about each of the plurality of the TRPs.

In an embodiment, the representative information may be determined based on, among the configuration information for repeatedly transmitting the PUSCH to the plurality of the TRPs, configuration information including a value that corresponds to one parameter or a combination of a plurality of parameters is a largest value or a smallest value or configuration information corresponding to a transmission point with a smallest index.

In an embodiment, the at least one processor may be further configured to determine at least one of the transport block size and the LDPC BG for repetition transmission of the PUSCH, based on configuration information by which a first PUSCH is scheduled, among the configuration information for repeatedly transmitting the PUSCH to the plurality of the TRPs.

In an embodiment, the at least one processor may be further configured to identify a plurality of pieces of configuration information respectively corresponding to the plurality of the TRPs, from the configuration information for repeatedly transmitting the PUSCH to the plurality of the TRPs, determine a plurality of transport block sizes respectively corresponding to the plurality of the TRPs, from the plurality of pieces of identified configuration information, identify a smallest transport block size among the plurality of transport block sizes, and encode the plurality of PUSCHs to be repeatedly transmitted to the plurality of TRPs, based on the identified smallest transport block size.

In an embodiment, the configuration information for repeatedly transmitting the PUSCH to the plurality of TRPs may include a restriction configured by the BS to equally match transport block sizes and LDPC BGs for the PUSCHs to be transmitted to the plurality of TRPs.

In an embodiment, the restriction may indicate a case where at least one of a number of resource elements (REs), a code rate, a modulation order, and a number of layers is equal.

In an embodiment, the configuration information for repeatedly transmitting the PUSCH to the plurality of TRPs may include one control information for scheduling all PUSCHs for the plurality of the TRPs or a plurality of pieces of control information for respectively scheduling PUSCHs for the plurality of the TRPs.

In an embodiment, the at least one processor may be further configured to report, to the BS, a capability report on PUSCH repetition transmissions via the plurality of the TRPs, and receive, from the BS, information indicating repetition transmission of the PUSCH, based on the capability report on the PUSCH repetition transmissions via the plurality of the TRPs.

In an embodiment, the at least one processor may be further configured to identify a number of REs, a code rate, a modulation order, and a number of layers from the configuration information for repeatedly transmitting the PUSCH to the plurality of TRPs, determine the transport block size, based on the number of REs, the code rate, the modulation order, and the number of layers, and determine the LDPC BG, based on the determined transport block size.

According to an embodiment of the disclosure, a BS for transmitting or receiving a signal in a wireless communication system may include a transceiver, and at least one processor. The at least one processor may be configured to transmit, to a UE, configuration information for repeatedly transmitting a PUSCH to a plurality of TRPs, receive a PUSCH being repeatedly transmitted from the UE, determine at least one of a transport block size and a LDPC BG, based on the configuration information for repeatedly transmitting the PUSCH to the plurality of TRPs, and decode the received PUSCH being repeatedly transmitted, based on at least one of the transport block size and the LDPC BG.

### MODE OF DISCLOSURE

Hereinafter, embodiments of the disclosure will now be described more fully with reference to the accompanying drawings.

When embodiments are described herein, a description of techniques which are well known in the technical field to which the disclosure pertains and are not directly related to the disclosure will be omitted. This is to clearly convey the concept of the disclosure by omitting descriptions of unnecessary details.

For the same reasons, in the drawings, some elements may be exaggerated, omitted, or roughly illustrated. Also, size of each element does not exactly correspond to an actual size of each element. In each drawing, elements that are the same or are in correspondence are rendered the same reference numeral.

Advantages and features of the disclosure and methods of accomplishing the same may be understood more readily by reference to the following detailed descriptions of embodiments and accompanying drawings of the disclosure. The disclosure may, however, be embodied in many different forms and should not be construed as being limited to the embodiments set forth herein; rather, these embodiments of the disclosure are provided so that this disclosure will be thorough and complete, and will fully convey the concept of the disclosure to one of ordinary skill in the art. Therefore, the scope of the disclosure is defined by the appended claims. Throughout the specification, like reference numerals refer to like elements.

It will be understood that each block of flowchart illustrations, and combinations of blocks in the flowchart illustrations, may be implemented by computer program instructions. The computer program instructions may be provided to a processor of a general-purpose computer, special purpose computer, or other programmable data processing apparatus, such that the instructions, which are executed via the processor of the computer or other programmable data processing apparatus, generate means for performing functions specified in the flowchart block(s). The computer program instructions may also be stored in a computer-executable or computer-readable memory that may direct the computer or other programmable data processing apparatus to function in a particular manner, such that the instructions stored in the computer-executable or computer-readable memory may produce an article of manufacture including instruction means that perform the functions specified in the flowchart block(s). The computer program instructions may also be loaded onto the computer or other programmable data processing apparatus to cause a series of operations to be performed on the computer or other programmable apparatus to produce a computer implemented process such that the instructions that are executed on the computer or other programmable apparatus provide operations for implementing the functions specified in the flowchart block(s).

In addition, each block of the flowchart illustrations may represent a module, segment, or portion of code, which includes one or more executable instructions for performing specified logical function(s). It should also be noted that, in some alternative implementations, the functions noted in the blocks may occur out of the order. For example, two blocks shown in succession may in fact be executed substantially concurrently or the blocks may sometimes be executed in the reverse order, depending upon the functionality involved.

The term “ . . . unit”, as used in the present embodiment of the disclosure refers to a software or hardware component, such as field-programmable gate array (FPGA) or application-specific integrated circuit (ASIC), which performs certain tasks. However, the term “ . . . unit” does not mean to be limited to software or hardware. A “ . . . unit” may be configured to be in an addressable storage medium or configured to operate one or more processors. Thus, according to some embodiments, a “ . . . unit” may include components such as software components, object-oriented software components, class components, and task components, processes, functions, attributes, procedures, subroutines, segments of program code, drivers, firmware, microcode, circuitry, data, databases, data structures, tables, arrays, and variables. The functionality provided in the components and “ . . . units” may be combined into fewer components and “ . . . units” or further separated into additional components and “ . . . units”. Further, the components and “ . . . units” may be implemented to operate one or more central processing units (CPUs) in a device or a secure multimedia card. Also, according to some embodiments, a “ . . . unit” may include one or more processors.

Hereinafter, operational principles of the disclosure will be described in detail with reference to accompanying drawings. In the following descriptions of the disclosure, well-known functions or configurations are not described in detail because they would obscure the disclosure with unnecessary details. The terms used in the specification are defined in consideration of functions used in the disclosure, and may be changed according to the intent or known methods of operators and users. Accordingly, definitions of the terms should be understood based on the entire description of the present specification.

Hereinafter, a base station is an entity that allocates resources to a terminal, and may be at least one of a gNB, an eNB, a Node B, a base station (BS), a radio access unit, a BS controller, or a node on a network. A terminal may include a user equipment (UE), a mobile station (MS), a cellular phone, a smartphone, a computer, or a multimedia system capable of performing a communication function. However, the disclosure is not limited to the above example. Hereinafter, the disclosure provides descriptions of a technology by which a UE receives broadcasting information from a BS in a wireless communication system. The disclosure relates to a communication technique and system therefor for converging an Internet of Things (IoT) technology and a 5^{th} generation (5G) communication system for supporting a higher data rate after a 4^{th} generation (4G) system. The disclosure is applicable to intelligent services (e.g., smart home, smart building, smart city, smart car or connected car, health care, digital education, retail, security, and safety services) based on 5G communication technology and IoT technology.

Hereinafter, terms indicating broadcasting information, terms indicating control information, terms related to communication coverage, terms indicating a state change (e.g., event), terms indicating network entities, terms indicating messages, terms indicating elements of an apparatus, or the like, as used in the following description, are exemplified for convenience of descriptions. Accordingly, the disclosure is not limited to terms to be described below, and other terms indicating objects having equal technical meanings may be used.

Hereinafter, for convenience of descriptions, some terms and names defined in the 3^{rd} Generation Partnership Project Long Term Evolution (3GPP LTE) standard may be used. However, the disclosure is not limited to these terms and names, and may be equally applied to systems conforming to other standards.

Wireless communication systems providing voice-based services in early stages are being developed to broadband wireless communication systems providing high-speed and high-quality packet data services according to communication standards such as high speed packet access (HSPA), long term evolution (LTE) or evolved universal terrestrial radio access (E-UTRA), LTE-advanced (LTE-A), LTE-Pro of 3GPP, high rate packet data (HRPD), ultra mobile broadband (UMB) of 3GPP2, and 802.16e of the Institute of Electrical and Electronics Engineers (IEEE).

As a representative example of the broadband wireless communication systems, LTE systems employ orthogonal frequency division multiplexing (OFDM) for a downlink (DL) and employs single carrier-frequency division multiple access (SC-FDMA) for an uplink (UL). The UL refers to a radio link for transmitting data or a control signal from a terminal (e.g., a UE or an MS) to a base station (e.g., an eNB or a BS), and the DL refers to a radio link for transmitting data or a control signal from the base station to the terminal. The above-described multiple access schemes identify data or control information of each user in a manner that time-frequency resources for carrying the data or control information of each user are allocated and managed not to overlap each other, that is, to achieve orthogonality therebetween.

As post-LTE communication systems, i.e., 5G communication systems need to support services capable of freely reflecting and simultaneously satisfying various requirements of users, service providers, and the like. Services considered for the 5G systems include enhanced mobile broadband (eMBB), massive machine-type communication (mMTC), ultra-reliability low-latency communication (URLLC) services, or the like.

According to some embodiments, the eMBB aims to provide an improved data rate than a data rate supported by the legacy LTE, LTE-A, or LTE-Pro. For example, in a 5G communication system, the eMBB should be able to provide a peak data rate of 20 Gbps in a DL and a peak data rate of 10 Gbps in an UL at one BS. Also, it has to simultaneously provide a peak data rate and an increased user-perceived data rate of a terminal. In order to satisfy such requirements, there is a need for improvement in various transmission/reception technologies including an improved multiple-input multiple-output (MIMO) transmission technology. Also, a data rate required in the 5G communication system may be satisfied as the 5G communication system uses a frequency bandwidth wider than 20 MHz in the 3 GHz to 6 GHz or 6 GHz or more frequency band, while the legacy LTE uses a 2 GHz band.

Simultaneously, the mMTC is being considered to support application services such as IoT in 5G communication systems. In order to efficiently provide the IoT, the mMTC may require the support for a large number of terminals in a cell, improved coverage for a terminal, improved battery time, reduced costs of a terminal, and the like. Because the IoT is attached to various sensors and various devices to provide a communication function, the mMTC should be able to support a large number of terminals (e.g., 1,000,000 terminals/km²) in a cell. Also, because a terminal supporting the mMTC is likely to be located in a shadow region failing to be covered by the cell, such as the basement of a building, due to the characteristics of the service, the terminal may require wider coverage than other services provided by the 5G communication systems. The terminal supporting the mMTC should be configured as a low-cost terminal and may require a very long battery life time such as 10 to 15 years because it is difficult to frequently replace the battery of the terminal.

Lastly, the URLLC refers to cellular-based wireless communication services used for mission-critical purposes such as services for remote control of robots or machinery, industrial automation, unmanned aerial vehicles, remote health care, emergency alerts, and the like, and should provide communications providing ultra-low latency and ultra reliability. For example, a service supporting the URLLC should satisfy air interface latency of less than 0.5 milliseconds, and simultaneously has a requirement for a packet error rate of 10⁻⁵ or less. Thus, for the service supporting the URLLC, the 5G system should provide a transmit time interval (TTI) smaller than other services and may simultaneously have a design requirement for allocating wide resources in a frequency band. However, the above-described mMTC, URLLC, and eMBB services are merely examples and the types of services to which the disclosure is applicable are not limited thereto.

Contents in the disclosure are applicable to a frequency division duplex (FDD) and time division duplex (TDD) system. However, the system is merely an example, and thus, embodiments of the disclosure are not limited to the FDD and TDD system and may be applied to various systems.

Hereinafter, higher layer signaling in the disclosure refers to a method of transmitting a signal from a BS to a UE by using a DL data channel of a physical layer or from the UE to the BS by using an UL data channel of a physical channel, and may be referred to as radio resource control (RRC) signaling or packet data convergence protocol (PDCP) signaling or a medium access control control element (MAC CE).

The services considered in the 5G communication system need to be provided after being converged based on one framework. That is, in order to efficiently managing and controlling resources, it is preferable that the services are combined into one system and then are controlled and transmitted, rather than independently operating.

Although LTE, LTE-A, LTE Pro, or New Radio (NR) systems are mentioned as examples in the following description, embodiments of the disclosure may also be applied to other communication systems having similar technical backgrounds or channel types. Furthermore, the embodiments of the disclosure may also be applied to other communication systems through partial modification without greatly departing from the scope of the disclosure based on determination by one of ordinary skill in the art.

The disclosure relates to a method and apparatus for reporting channel state information (CSI) to improve power saving efficiency of a UE.

According to the disclosure, when a UE operates in a power saving mode in a wireless communication system, a method of reporting CSI is optimized according to the mode, such that a power saving effect may be further improved.

Hereinafter, a frame structure of a 5G system will now be described in detail with reference to drawings.

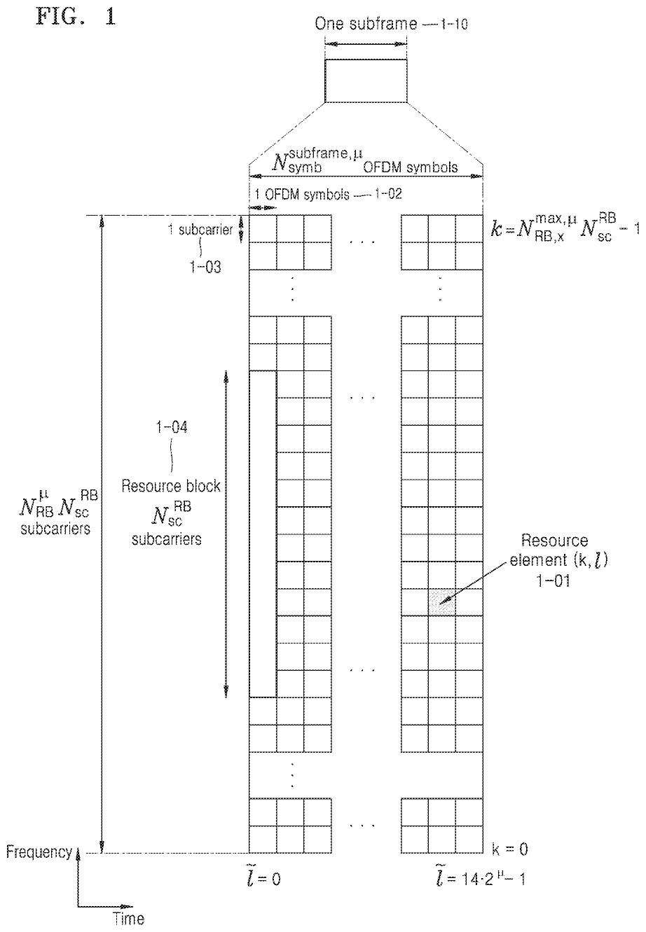

FIG. 1 is a diagram illustrating a basic structure of a time-frequency domain of a wireless communication according to an embodiment of the disclosure.

Referring to FIG. 1, the horizontal axis represents a time domain and the vertical axis represents a frequency domain in FIG. 1. A basic unit of a resource in the time-frequency domain is a resource element (RE) 1-01 and may be defined as 1 OFDM symbol 1-02 in the time domain and 1 subcarrier 1-03 in the frequency domain. In the frequency domain, NP (e.g., 12) consecutive REs may constitute one resource block (RB) 1-04. In an embodiment, a plurality of OFDM symbols may constitute one subframe 1-10.

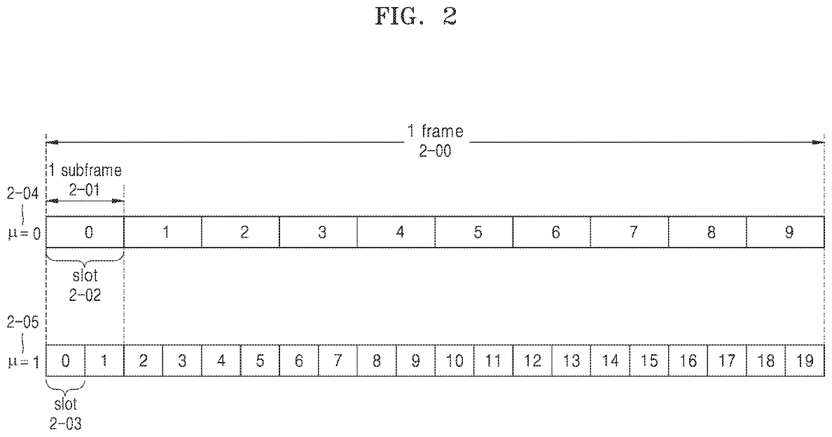

FIG. 2 is a diagram illustrating structures of a frame, a subframe, and a slot in a next-generation wireless communication system according to an embodiment of the disclosure.

FIG. 2 illustrates an example of structures of a frame 2-00, a subframe 2-01, and a slot 2-02. One frame 2-00 may be defined as 10 ms. One subframe 2-01 may be defined as 1 ms, and thus, one frame 2-00 may consist of 10 subframes 2-01. One slot 2-02 or 2-03 may be defined as 14 OFDM symbols (That is, the number of symbols per 1 slot (N_{symb}^{slot})=14). One subframe 2-01 may consist of one or more slots 2-02 or 2-03, and the number of slots 2-02 or 20-3 per one subframe 2-01 may vary according to a configuration value p 2-04 or 2-05 indicating a configuration of a subcarrier spacing. The example of FIG. 2 shows a case 2-04 in which μ=0 and a case 2-05 in which μ=1, as a configuration value of a subcarrier spacing. When μ=0 (2-04), one subframe 2-01 may consist of one slot 2-02, and when μ=1 (2-05), one subframe 2-01 may consist of two slots 2-03. That is, the number of slots per one subframe (Nₛₗₒₜ^{subframe,μ}) may vary according to a configuration value p with respect to a subcarrier spacing, and thus, the number of slots per one frame (Nₛₗₒₜ^{frame,μ}) may vary accordingly. Nₛₗₒₜ^{subframe,μ} and Nₛₗₒₜ^{frame,μ} according to each subcarrier spacing configuration p may be defined as in Table 1 below.

TABLE 1

| μ | N_{symb}^{slot} | Nₛₗₒₜ^{frame,μ} | Nₛₗₒₜ^{subframe,μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

In new radio (NR), one component carrier (CC) or one serving cell may consist of up to at least 250 resource blocks (RBs). Accordingly, in a case where a UE always receives a full serving cell bandwidth as in LTE, power consumption in the UE may be severe, and to salve this issue, a BS may configure the UE with one or more bandwidth parts (BWPs) to allow the UE to change a reception region in a cell. In the NR, the BS may configure the UE with an initial BWP that is a bandwidth of control resource set (CORESET) #0 (or a common search space (CSS)) via a master information block (MIB). Afterward, the BS may configure a first BWP for the UE by RRC signaling, and may notify one or more pieces of BWP configuration information that may be indicated by downlink control information (DCI). Afterward, the BS may indicate which BWP the UE is to use, by notifying an identifier (ID) of a BWP by DCI. In a case where the UE cannot receive DCI on a current allocated BWP for a particular time period, the UE may return to a default BWP and then may attempt to receive the DCI.

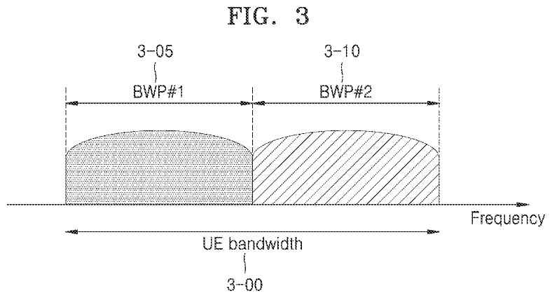

FIG. 3 is a diagram illustrating an example of configuration of BWPs in a wireless communication system according to an embodiment of the disclosure.

In the example of FIG. 3, UE bandwidth 3-00 is configured into two BWPs, i.e., BWP#1 301 and BWP#2 302. A BS may configure a UE with one or more BWPs, and may configure, for each BWP, a plurality of pieces of information as in Table 2 below.

TABLE 2

| | |
|---|---|
| BWP ::= | SEQUENCE { |
| bwp-Id | BWP-Id, |
| locationAndBandwidth | INTEGER (1..65536), |
| subcarrierSpacing | ENUMERATED {n0, n1, n2, n3, n4, n5}, |
| cyclicPrefix | ENUMERATED { extended } |
| } | |

The disclosure is not limited to the example, and thus, various parameters associated with the BWP may be configured for the UE, in addition to the configuration information described with reference to Table 2 above. The plurality of pieces of information may be transmitted from the BS to the UE by higher layer signaling, e.g., RRC signaling. At least one BWP among the configured one or more BWPs may be activated. Whether to activate a configured BWP may be notified from the BS to the UE semi-statically by RRC signaling or dynamically by a MAC CE or DCI.

According to an embodiment, the UE may be configured by the BS with an initial BWP for initial access in an MIB before the UE is RRC connected. In more detail, the UE may receive configuration information for a control resource set (CORESET) and search space in which a physical downlink control channel (PDCCH) may be transmitted for receiving system information (e.g., remaining system information (RMSI) or system information block 1 (SIB1)), based on the MIB, requested for initial access in an initial access process. Each of the control resource set and the search space which hare configured in the MIB may be regarded with identity (ID) 0.

The BS may notify, in the MIB, the UE of configuration information such as frequency allocation information, time allocation information, numerology, etc., for control resource set #0. Also, the BS may notify, in the MIB, the UE of configuration information such as a monitoring periodicity and occasion for the control resource set #0, i.e., configuration information for search space #0. The UE may regard a frequency region configured as the control resource set #0 obtained from the MIB, as the initial BWP for initial access. Here, the ID of the initial BWP may be regarded as 0.

Configuration of the BWP supported by the next-generation wireless communication system (the 5G or NR system) may be used for various purposes.

For example, when a bandwidth supported by the UE is smaller than a system bandwidth, the bandwidth supported by the UE may be supported via configuration of the BWP. For example, the BS may configure the UE with a frequency location of the BWP (configuration information 2) in Table 2, and the UE may transmit or receive data in a particular frequency location in the system bandwidth.

Also, according to an embodiment, in order to support different numerologies, the BS may configure a plurality of BWPs for the UE. For example, in order to support data transmission and reception using both 15 KHz subcarrier spacing and 30 KHz subcarrier spacing for a certain UE, the BS may configure two BWPs with 15 KHz and 30 KHz subcarrier spacings, respectively. The different BWPs may be frequency division multiplexed, and in a case where a UE attempts to transmit and receive data with particular subcarrier spacing, a BWP configured with the subcarrier spacing may be activated.

As another example, in order to reduce power consumption of the UE, the BS may configure BWPs with different bandwidth sizes for the UE. For example, when the UE supports very large bandwidth, e.g., 100 MHz bandwidth, and always transmits or receives data in the bandwidth, very high power consumption may occur. In particular, in a situation where there is no traffic, if the UE monitors unnecessary DL control channel in the large 100 MHz bandwidth, this may be very inefficient in terms of power consumption. In order to reduce the power consumption of the UE, the BS may configure a BWP with relatively small bandwidth, e.g., a 20 MHz BWP, for the UE. In the situation that there is no traffic, the UE may perform monitoring in the 20 MHz BWP, and when data occurs, the UE may transmit or receive the data on the 100 MHz BWP based on an indication from the BS.

In a method of configuring a BWP, UEs before being RRC connected may receive, based on the MIB, configuration information for the initial BWP in an initial access process. In more specific, the UE may be configured, based on the MIB of a physical broadcast channel (PBCH), with a control resource set for a DL control channel on which DCI for scheduling a system information block (SIB) may be transmitted. A bandwidth of the control resource set configured in the MIB may be regarded as the initial BWP, and the UE may receive, on the initial BWP, a physical downlink shared channel (PDSCH) on which the SIB is transmitted. The initial BWP may also be used for other system information (OSI), paging, or random access, in addition to reception of the SIB.

Hereinafter, a synchronization signal (SS)/PBCH block in the next-generation wireless communication system (the 5G or NR system) will now be described.

An SS/PBCH block may refer to a physical layer channel block including primary SS (PSS), secondary SS (SSS), and PBCH. In more detail, the SS/PBCH block may be defined as below.
PSS: a reference signal for DL time/frequency synchronization, which may provide partial information of a cell ID.
SSS: a reference signal for DL time/frequency synchronization, which may provide the rest of the cell ID information not provided by the PSS. In addition, the SSS may serve as another reference signal for demodulation of the PBCH.
PBCH: The PBCH may provide essential system information requested for the UE to transmit or receive data channel and control channel. The essential system information may include search-space-associated control information indicating radio resource mapping information of the control channel, scheduling control information for a separate data channel to transmit system information, and the like.
SS/PBCH block: The SS/PBCH block may be a combination of PSS, SSS, and PBCH. One or more SS/PBCH blocks may be transmitted in 5 ms, and each of the SS/PBCH blocks may be identified by an index.

The UE may detect the PSS and the SSS in the initial access process, and may decode the PBCH. The UE may obtain an MIB from the PBCH and may be configured with control resource set (CORESET) #0 via the MIB. The UE may assume that a demodulation reference signal (DMRS) transmitted in the selected SS/PBCH block and control resource set #0 are quasi-co-located (QCL), and may perform monitoring on the CORESET #0. The UE may receive system information based on the DL control information transmitted in the control resource set #0. The UE may obtain random-access-channel (RACH) related configuration information required for initial access from the received system information. The UE may transmit, to the BS, a physical RACH (PRACH) by considering the selected SS/PBCH index, and upon reception of the PRACH, the BS may obtain information about the SS/PBCH block index selected by the UE. The BS may identify that the UE has selected a certain block among the SS/PBCH blocks and monitors the control resource set #0 corresponding to (or associated with) the selected SS/PBCH.

Hereinafter, DCI in the next-generation wireless communication system (the 5G or NR system) will now be described in detail.

In the next-generation wireless communication system (the 5G or NR system), scheduling information for UL data (or physical uplink shared channel (PUSCH)) or DL data (or PDSCH) is transmitted in the DCI from the BS to the UE. The UE may monitor a fallback DCI format and a non-fallback DCI format for PUSCH or PDSCH. The fallback DCI format may include a fixed field predefined between the BS and the UE, and the non-fallback DCI format may include a configurable field.

DCI may be transmitted on a PDCCH after channel coding and modulation processes. Cyclic redundancy check (CRC) may be added to a DCI message payload, and the CRC may be scrambled by a radio network temporary identifier (RNTI) that corresponds to an ID of the UE. Depending on a purpose of the DCI message, e.g., UE-specific data transmission, power control command, random access response, or the like, different RNTIs may be used for scrambling of the CRC to be added to the DCI message payload. That is, the RNTI may not be explicitly transmitted but may be transmitted in a CRC calculation process. Upon reception of a DCI message transmitted on the PDCCH, the UE may check CRC by using an allocated RNTI. The UE may identify that the DCI message is transmitted to the UE, based on a result of the CRC checking.

For example, DCI that schedules a PDSCH for system information (SI) may be scrambled by SI-RNTI. DCI that schedules a PDSCH for a random access response (RAR) message may be scrambled by an RA-RNTI. DCI that schedules a PDSCH for a paging message may be scrambled by a P-RNTI. DCI that notifies a slot format indicator (SFI) may be scrambled by an SFI-RNTI. DCI that notifies a transmit power control (TPC) may be scrambled by a TPC-RNTI. DCI that schedules UE-specific PDSCH or PUSCH may be scrambled by a Cell RNTI (C-RNTI).

DCI format 0_0 may be used for the fallback DCI that schedules a PUSCH, and here, the CRC may be scrambled by a C-RNTI. In an embodiment, the DCI format 0_0 with the CRC scrambled by the C-RNTI may include a plurality of pieces of information shown in Table 3 below.

TABLE 3

| | |
|---|---|
| - | Identifier for DCI formats −[1] bit |
| - | Frequency domain resource assignment − [┌log₂(N_{RB}^{UL,BWP}(N_{RB}^{UL,BWP} +1)/2)┐] bits |
| - | Time domain resource assignment − X bits |
| - | Frequency hopping flag − 1 bit. |
| - | Modulation and coding scheme- 5 bits |
| - | New data indicator − 1 bit |
| - | Redundancy version − 2 bits |
| - | HARQ process number − 4 bits |
| - | TPC command for scheduled PUSCH − [2] bits |
| - | UL/SUL indicator − 0 or 1 bit |

DCI format 0_1 may be used for the non-fallback DCI that schedules a PUSCH, and here, the CRC may be scrambled by a C-RNTI. In an embodiment, the DCI format 0_1 with the CRC scrambled by the C-RNTI may include a plurality of pieces of information shown in Table 4 below.

```
TABLE 4
  Carrier indicator-0 or 3 bits
  UL/SUL indicator-0 or 1 bit
  Identifier for DCI formats-[1] bits
  Bandwidth part indicator-0, 1 or 2 bits
  Frequency domain resource assignment
    For resource allocation type 0, ┌N_{RB}^{UL,BWP}/P┐ bits
    For resource allocation type 1, ┌log₂(N_{RB}^{UL,BWP}(N_{RB}^{UL,BWP} + 1)/2┐
    bits
  Time domain resource assignment-1, 2, 3, or 4 bits
  VRB-to-PRB mapping (virtual resource block-to-physical resource
block mapping)-0 or 1 bit, only for resource allocation type 1.
    0 bit if only resource allocation type 0 is configured;
    1 bit otherwise.
  Frequency hopping flag-0 or 1 bit, only for resource allocation type 1.
    0 bit if only resource allocation type 0 is configured;
    1 bit otherwise.
  Modulation and coding scheme-5 bits
  New data indicator-1 bit
  Redundancy version-2 bits
  HARQ process number-4 bits
  1st downlink assignment index-1 or 2 bits
    1 bit for semi-static HARQ-ACK codebook;
    2 bits for dynamic HARQ-ACK codebook with single HARQ-ACK
    codebook.
  2nd downlink assignment index-0 or 2 bits
    2 bits for dynamic HARQ-ACK codebook with two HARQ-ACK sub-
    codebooks;
    0 bit otherwise.
  TPC command for scheduled PUSCH-2 bits
  $SRS resource indicator - ⌈ {log}_{2} ( {\sum }_{k = 1}^{{L}_{max}} ( \begin{matrix}{N}_{SRS} \\ k\end{matrix} ) ) ⌉ or ⌈ {log}_{2} ( {N}_{SRS} ) ⌉ bits$
    $⌈ {log}_{2} ( {\sum }_{k = 1}^{{L}_{max}} ( \begin{matrix}{N}_{SRS} \\ k\end{matrix} ) ) ⌉ bits for non - codebook based$
    PUSCH transmission;
    ┌log₂(N_{SRS})┐ bits for codebook based PUSCH transmission.
  Precoding information and number of layers-up to 6 bits
  Antenna ports-up to 5 bits
  SRS request-2 bits
  CSI request-0, 1, 2, 3, 4, 5, or 6 bits
  CBG transmission information-0, 2, 4, 6, or 8 bits
  PTRS-DMRS association-0 or 2 bits.
  beta_offset indicator-0 or 2 bits
  DMRS sequence initialization-0 or 1 bit
```

DCI format 1_0 may be used for the fallback DCI that schedules a PDSCH, and here, the CRC may be scrambled by a C-RNTI. In an embodiment, the DCI format 1_0 with the CRC scrambled by the C-RNTI may include a plurality of pieces of information shown in Table 5 below.

TABLE 5

| | |
|---|---|
| - | Identifier for DCI formats - [1] bit |
| - | Frequency domain resource assignment - [┌log₂(N_{RB}^{DL,BWP}(N_{RB}^{DL,BWP} +1)/2)┐] bits |
| - | Time domain resource assignment - X bits |
| - | VRB-to-PRB mapping - 1 bit. |
| - | Modulation and coding scheme - 5 bits |
| - | New data indicator - 1 bit |
| - | Redundancy version - 2 bits |
| - | HARQ process number - 4 bits |
| - | Downlink assignment index - 2 bits |
| - | TPC command for scheduled PUCCH - [2] bits |
| - | PUCCH resource indicator - 3 bits |
| - | PDSCH-to-HARQ feedback timing indicator - 3 bits |

Alternatively, DCI format 1_0 may be used for DCI that schedules a PDSCH for an RAR message, and here, a CRC may be scrambled by an RA-RNTI. The DCI format 1_0 with the CRC scrambled by the C-RNTI may include a plurality of pieces of information shown in Table 6 below.

TABLE 6

| | |
|---|---|
| - | Frequency domain resource assignment - ┌log₂(N_{RB}^{DL,BWP}(N_{RB}^{DL,BWP} + 1)/2)┐ bits |
| - | Time domain resource assignment - 4 bits |
| - | VRB-to-PRB mapping - 1 bit |
| - | Modulation and coding scheme - 5 bits |
| - | TB scaling - 2 bits |
| - | Reserved bits - 16 bits |

DCI format 1_1 may be used for the non-fallback DCI that schedules a PDSCH, and here, the CRC may be scrambled by a C-RNTI. In an embodiment, the DCI format 1_1 with the CRC scrambled by the C-RNTI may include a plurality of pieces of information shown in Table 7 below.

TABLE 7

| | |
|---|---|
| - | Carrier indicator - 0 or 3 bits |
| - | Identifier for DCI formats - [1] bits |
| - | Bandwidth part indicator - 0, 1 or 2 bits |
| - | Frequency domain resource assignment |
| | · For resource allocation type 0, ┌N_{RB}^{DL,BWP}/P┐ bits |
| | · For resource allocation type 1, ┌log₂(N_{RB}^{DL,BWP}(N_{RB}^{DL,BWP} + 1)/2)┐] bits |
| - | Time domain resource assignment -1, 2, 3, or 4 bits |
| - | VRB-to-PRB mapping - 0 or 1 bit, only for resource allocation type 1. |
| | · 0 bit if only resource allocation type 0 is configured; |
| | · 1 bit otherwise. |
| - | PRB bundling size indicator - 0 or 1 bit |
| - | Rate matching indicator - 0, 1, or 2 bits |
| - | ZP CSI-RS trigger - 0, 1, or 2 bits |

```
  For transport block 1:
    Modulation and coding scheme - 5 bits
    New data indicator -1 bit
    Redundancy version - 2 bits
  For transport block 2:
    Modulation and coding scheme - 5 bits
    New data indicator -1 bit
    Redundancy version - 2 bits
```

| | |
|---|---|
| - | HARQ process number - 4 bits |
| - | Downlink assignment index - 0 or 2 or 4 bits |
| - | TPC command for scheduled PUCCH - 2 bits |
| - | PUCCH resource indicator - 3 bits |
| - | PDSCH-to-HARQ_feedback timing indicator - 3 bits |
| - | Antenna ports -4, 5 or 6 bits |
| - | Transmission configuration indication - 0 or 3 bits |
| - | SRS request - 2 bits |
| - | CBG transmission information - 0, 2, 4, 6, or 8 bits |
| - | CBG flushing out information - 0 or 1 bit |
| - | DMRS sequence initialization - 1 bit |

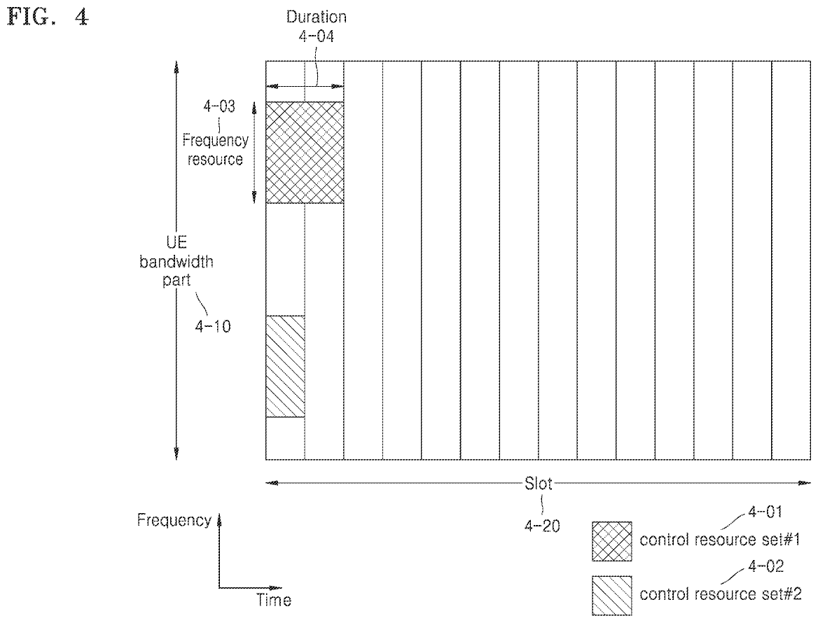

FIG. 4 is a diagram for describing control resource set configuration of a DL control channel of the next-generation wireless communication system according to an embodiment of the disclosure. In more detail, FIG. 4 is a diagram illustrating an example of control resource sets (or CORESETs) in which a DL control channel is transmitted in the 5G wireless communication system according to an embodiment of the disclosure.

Referring to FIG. 4, UE BWP 4-10 may be configured on the frequency domain, and two control resource sets (control resource set #1 4-01 and control resource set #2 4-02) may be configured in a slot 4-20 on the time domain. The control resource sets 4-01 and 4-02 may be configured on a particular frequency resource 4-03 in the full UE BWP 4-10 on the frequency domain. The control resource sets 4-01 and 4-02 may be configured as one or more OFDM symbols on the time domain, and may be defined as control resource set duration 4-04. Referring to FIG. 4, resource set duration of the control resource set #1 4-01 may be configured as two symbols, and resource set duration of the control resource set #2 4-02 may be configured as one symbol.

The control resource set in the next-generation wireless communication system (the 5G or NR system) described above may be configured by higher layer signaling (e.g., system information (SI), MIB, or RRC signaling) between the BS and the UE. Configuring the UE with a control resource set may be understood as providing the UE with information such as a control resource set ID, a frequency location of the control resource set, length of symbols of the control resource set, or the like. For example, the configuration of the control resource set may include a plurality of pieces of information shown in Table 8 below.

TABLE 8

```
ControlResourceSet ::=  SEQUENCE{
  -- Corresponds to L1 parameter ‘CORESET-ID’
  control ResourceSetId  ControlResourceSetId,
  ( [symbol]   (Identity))
  frequencyDomainResources  BIT STRING (SIZE (45)),
  ( [symbol] [symbol]     )
  duration INTEGER (1..maxCoReSetDuration),
  ( [symbol] [symbol]     )
  cce-REG-MappingType  CHOICE {
  (CCE-to-REG [symbol]   )
    interleaved SEQUENCE {
      reg-BundleSize ENUMERATED (n2, n3, n6},
          (REG [symbol]  )
      precoderGranularity ENUMERATED (sameAsREG-bundle,
    allContiguousRBs},
      interleaverSize ENUMERATED {n2, n3, n6}
      ( [symbol]   )
      shiftIndex
      INTEGER(0..maxNrofPhysicalResourceBlocks-1)
      ( [symbol] [symbol]     (Shift))
      },
    nonInterleaved NULL
    },
    tci-StatesPDCCH SEQUENCE(SIZE (1.maxNrofTCI-
    StatesPDCCH)) OF TCI-StateId OPTIONAL,
    (QCL [symbol]  )
  tci-PresentInDCI ENUMERATED {enabled}
}
```

In Table 8, tci-StatesPDCCH (i.e., transmission configuration indication (TCI) state) configuration information may include information about channel state information reference signal (CSI-RS) indexes or one or more SS/PBCH block indexes having a QCL relation with a DMRS transmitted in the corresponding control resource set.

One or more different antenna ports (which may be substituted with one or more channels, signals, or combinations thereof, but for convenience of descriptions in the disclosure, collectively called different antenna ports) may be associated with each other according to QCL configurations described in Table 9 below in a wireless communication system.

TABLE 9

| | |
|---|---|
| QCL-Info ::= | SEQUENCE { |
| cell | ServCellIndex (index of serving |
| | cell in which QCL reference RS is |
| | transmitted) |
| bwp-Id | BWP-Id (index of BNP on which QCL |
| | reference RS is transmitted) |
| referenceSignal | CHOICE {indicator indicating |
| | one of CSI-RS or SS/PBCH block |
| | as QCL reference RS} |
| csi-rs | NZP-CSI-RS-ResourceId, |
| ssb | SSB-Index |
| }, | |
| qcl-Type | ENUMERATED {typeA, typeB, typeC, |
| | typed}, (QCL type indicator) |
| ... | |
| } | |

In more detail, QCL configuration may associate two different antenna ports as a relation of a (QCL) target antenna port and a (QCL) reference antenna port, and the UE may apply (or assume) all or some of channel statistical features (e.g., large scale parameters of a channel which include Doppler shift, Doppler spread, average delay, delay spread, average gain, spatial Rx (or Tx) parameter or the like, a reception spatial filter coefficient or transmission spatial filter coefficient of the UE), which are measured from the reference antenna port, to reception of the target antenna port. The target antenna port refers to an antenna port to transmit a channel or signal configured by higher layer configuration including the QCL configuration or an antenna port to transmit a channel or signal to which a TCI state indicating the QCL configuration is applied. The reference antenna port refers to an antenna port to transmit a channel or signal indicated (or specified) by referenceSignal parameter in the QCL configuration.

In more detail, the channel statistical features defined by the QCL configuration (indicated by qcl-Type parameter in the QCL configuration) may be classified below according to QCL types.
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

Here, QCL types are not limited to the four types above, and all possible combinations are not listed here not to obscure the essence of the description. QCL-TypeA above is a QCL type used all statistical features being measurable on the frequency domain and the time domain can be referenced because a bandwidth and transmission period of the target antenna port are all sufficient compared to the reference antenna port (i.e., when the number of samples and transmission band/time of the target antenna port are more than the number of samples and transmission band/time of the reference antenna port on both the frequency domain and the time domain). QCL-TypeB is a QCL type used when a bandwidth of the target antenna port is sufficient for measurement of Doppler shifts and Doppler spreads that are statistical features being measurable on the frequency domain. QCL-TypeC is a QCL type used when a bandwidth and transmission period of the target antenna port are insufficient for measurement of second-order statistics, i.e., Doppler shifts and Doppler spreads, such that only first-order statistics, i.e., Doppler shift and average delay, can be reference. QCL-TypeD is a QCL type used when spatial reception filter values used in reception of the reference antenna port can be used in reception of the target antenna port.

The BS may configure or indicate up to two QCL configurations for one target antenna port via TCI state configuration as in Table 10 below.

TABLE 10

| | |
|---|---|
| TCI- | SEQUENCE { |
| State :: | TCI-StateId, ( TCI state indicator ) |
| = | QCL-Info, ( first QCL configuration for |
| tci- | target antenna port to which |
| StateId | corresponding TCI state is applied ) |
| | QCL-Info (second QCL configuration for |
| qcl- | target antenna port to which |
| | corresponding TCI state is applied) |
| Type1 | |
| | OPTIONAL, -- Need R |

The first QCL configuration among the two QCL configurations included in one TCI state configuration may be configured as one of QCL-TypeA, QCL-TypeB, and QCL-TypeC. In this regard, a configurable QCL type is specified according to types of the target antenna port and the reference antenna port, and will now be described below. Also, the second QCL configuration among the two QCL configurations included in the one TCI state configuration may be configured as QCL-TypeD, and may be omitted in some cases.

Table 11-1 to Table 11-5 below are Tables indicating valid TCI state configurations according to types of the target antenna port.

Table 11-1 represents valid TCI state configuration when the target antenna port is a CSI-RS for tracking (tracking reference signal (TRS)). The TRS refers to NZP CSI-RS in which a repetition parameter is not configured but trs-Info is configured as true among CSI-RSs. Configurations #1 and #2 in Table 11-1 may be used when the target antenna port is a periodic TRS or a semi-persistent TRS, and configuration #3 may be used when the target antenna port is an aperiodic TRS.

TABLE 11-1
Valid TCI state configurations when target antenna port is
CSI-RS for tracking (TRS)

| Valid TCI | | | | |
|---|---|---|---|---|
| state | | | DL RS 2 | qcl-Type2 |
| Configur- | | | (if | (if |
| ation | DL RS 1 | qcl-Type1 | configured) | configured) |
| 2 | SSB | QCL-TypeC | SSB | QCL-TypeD |
| 2 | SSB | QCL-TypeC | CSI-RS (BM) | QCL-TypeD |
| 3 | TRS | QCL-TypeA | TRS (same as | QCL-TypeD |
| | (periodic) | | DL RS 1) | |

Table 11-2 represents valid TCI state configurations when the target antenna port is a CSI-RS for CSI. The CSI-RS for CSI refers to an NZP CSI-RS in which a repetition parameter is not configured and trs-Info is not configured to true among CSI-RSs.

TABLE 11-2
Valid TCI state configurations when target antenna port
is CSI-RS for CSI

| Valid TCI | | | | |
|---|---|---|---|---|
| state | | | DL RS 2 | qcl-Type2 |
| Configur- | | | (if | (if |
| ation | DL RS 1 | qcl-Type1 | configured) | configured) |
| 1 | TRS | QCL-TypeA | SSB | QCL-TypeD |
| 2 | TRS | QCL-TypeA | CSI-RS for BM | QCL-TypeD |
| 3 | TRS | QCL-TypeA | TRS (same as | QCL-TypeD |
| | | | DL RS 1) | |
| 4 | TRS | QCL-TypeB | | |

Table 11-3 represents valid TCI state configurations when the target antenna port is a CSI-RS for beam management (meaning the same as BM, CSI-RS for L1 reference signal received power (RSRP) reporting). The CSI-RS for BM refers to NZP CSI-RS in which a repetition parameter is configured and which has a value of ‘On’ or ‘Off’ and in which trs-Info is not configured to true among CSI-RSs.

TABLE 11-3
Valid TCI state configurations when target antenna port is
CSI-RS for BM (for L1 RSRP reporting)

| Valid TCI | | | | |
|---|---|---|---|---|
| state | | | DL RS 2 | qcl-Type2 |
| Configur- | | | (if | (if |
| ation | DL RS 1 | qcl-Type1 | configured) | configured) |
| 1 | TRS | QCL-TypeA | TRS (same as | QCL-TypeD |
| | | | DL RS 1) | |
| 2 | TRS | QCL-TypeA | CSI-RS (BM) | QCL-TypeD |
| 3 | SS/PBCH | QCL-TypeC | SS/PBCH | QCL-TypeD |
| | Block | | Block | |

Table 11-4 represents valid state configurations when the target antenna port is a PDCCH DMRS.

TABLE 11-4
Valid TCI state configurations when target antenna port is
PDCCH DMRS

| Valid TCI | | | | |
|---|---|---|---|---|
| state | | | DL RS 2 | qcl-Type2 |
| Configur- | | | (if | (if |
| ation | DL RS 1 | qcl-Type1 | configured) | configured) |
| 1 | TRS | QCL-TypeA | TRS (same as | QCL-TypeD |
| | | | DL RS 1) | |
| 2 | TRS | QCL-TypeA | CSI-RS (BM) | QCL-TypeD |
| 3 | CSI-RS | QCL-TypeA | CSI-RS (same | QCL-TypeD |
| | (CSI) | | as DL RS 1) | |

Table 11-5 represents valid TCI state configurations when the target antenna port is a PDSCH DMRS.

TABLE 11-5
Valid TCI state configurations when target antenna port is
PDSCH DMRS

| Valid TCI | | | | |
|---|---|---|---|---|
| state | | | DL RS 2 | qcl-Type2 |
| Configur- | | | (if | (if |
| ation | DL RS 1 | qcl-Type1 | configured) | configured) |
| 1 | TRS | QCL-TypeA | TRS | QCL-TypeD |
| 2 | TRS | QCL-TypeA | CSI-RS | QCL-TypeD |
| | | | (BM) | |
| 3 | CSI-RS | QCL-TypeA | CSI-RS | QCL-TypeD |
| | (CSI) | | (CSI) | |

A representative QCL configuration method according to Tables 11-1 to 11-5 above is to configure and operate a target antenna port and a reference antenna port in each stage as below: “SSB”->“TRS”->“CSI-RS for CSI, or CSI-RS for BM, or PDCCH DMRS, or PDSCH DMRS”. By doing so, it is possible to help a reception operation by the UE by associating statistical features that may be measured from the SSB and TRS with the respective antenna ports.

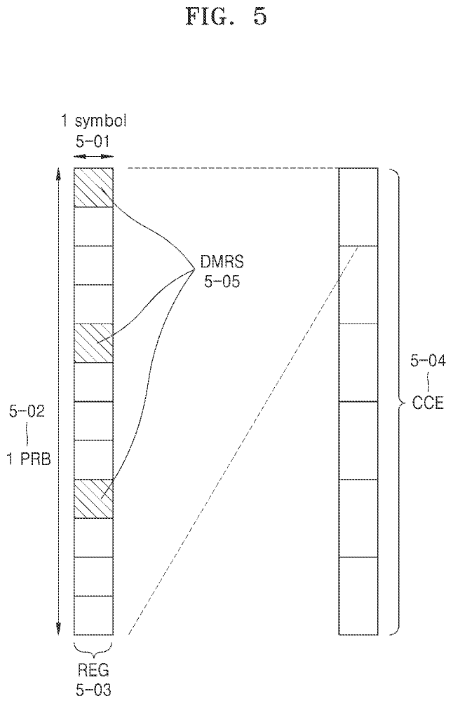

FIG. 5 is a diagram for describing a structure of a DL control channel of the next-generation wireless communication system according to an embodiment of the disclosure. In more detail, FIG. 5 is a diagram illustrating an example of a basic unit of time and frequency resources that configure a DL control channel being usable in the 5G communication system according to an embodiment of the disclosure.

Referring to FIG. 5, a basic unit of time and frequency resources that configure a control channel may be defined as a resource element group (REG) 5-03. The REG 5-03 may be defined by one OFDM symbol 5-01 on the time domain and one physical resource block (PRB) 5-02, i.e., 12 subcarriers, on the frequency domain. The BS may configure a DL control channel allocation unit by concatenating one or more REGs 5-03.

As illustrated in FIG. 5, when a basic unit with which the DL control channel is allocated is called a control channel element (CCE) 5-04 in the 5G system, the one CCE 5-04 may include a plurality of REGs 5-03. For example, the REG 5-03 shown in FIG. 5 may include 12 REs, and when one CCE 5-04 includes 6 REGs 5-03, the one CCE 5-04 may include 72 REs. When the DL control resource set is configured, it may include a plurality of CCEs 5-4, and a particular DL control channel may be transmitted by being mapped to one or more CCEs 5-04 based on an aggregation level (AL) in the control resource set. The CCEs 5-04 in the control resource set may be identified by numbers, and the numbers may be allocated to the CCEs 5-04 in a logical mapping scheme.

The basic unit of the DL control channel shown in FIG. 5, i.e., the REG 5-03, may include both REs to which DCI is mapped and a region to which DMRS 5-05 that is a reference signal for decoding the DCI is mapped. As shown in FIG. 5, three DMRSs 5-05 may be transmitted in one REG 5-03. The number of CCEs required to transmit the PDCCH may be 1, 2, 4, 8, or 16 depending on the AL, and different numbers of CCEs may be used to implement link adaptation of the DL control channel. For example, when AL=L, one DL control channel may be transmitted in L CCEs.

The UE needs to detect a signal without knowing information about the DL control channel, and search space representing a set of CCEs may be defined for the blind decoding. The search space is a set of DL control channel candidates that include CCEs on which the UE needs to attempt decoding at a given AL. Because there are various ALs each making a bundle with 1, 2, 4, 8, or 16 CCEs, the UE may have a plurality of search spaces. A search space set may be defined as a set of search spaces at all the configured ALs.

The search spaces may be classified into common search spaces and UE-specific search spaces. According to an embodiment of the disclosure, a certain group of UEs or all the UEs may monitor a common search space of the PDCCH so as to receive dynamic scheduling of the system information or receive cell-common control information such as a paging message.

For example, the UE may monitor the common search space of the PDCCH and thus may receive PDSCH scheduling allocation information for transmitting an SIB including cell operator information or the like. Because a certain group of UEs or all the UEs need to receive the PDCCH, the common search space may be defined as a set of pre-defined CCEs. The UE may receive UE-specific PDSCH or PUSCH scheduling allocation information by monitoring the UE-specific search space of the PDCCH. The UE-specific search space may be UE-specifically defined as a function of various system parameters and an ID of the UE.

In the 5G system, parameters of the search space of the PDCCH may be configured by the BS for the UE by higher layer signaling (e.g., SIB, MIB, or RRC signaling). For example, the BS may configure the UE with the number of PDCCH candidates at each AL, monitoring periodicity for the search space, monitoring occasion on symbols in the slot for the search space, a type of the search space (common search space or UE-specific search space), a combination of a DCI format to be monitored in the search space and an RNTI, a control resource set index to monitor the search space, or the like. For example, the afore-described configuration may include a plurality of pieces of information shown in Table 12 below.

TABLE 12

```
SearchSpace ::=  SEQUENCE {
  -- identity of the search space. SearchSpaceId = 0 identifies the SearchSpace
    configured via PBCH (MIB) or ServingCellConfigCommon.
  searchSpaceId SearchSpaceId,
  controlResourceSetId ControlResourceSetId,
  monitoringSlotPeriodicityAndOffset  CHOICE {
    sl1 NULL,
    sl2 INTEGER (0..1),
    sl4 INTEGER (0..3),
    sl5 INTEGER (0..4),
    sl8 INTEGER (0..7),
    sl10 INTEGER (0..9),
    sl16 INTEGER (0..15),
    sl20 INTEGER (0.. 19)
  }
  duration (monitoring length)  INTEGER (2..2559)
  monitoringSymbolsWithinSlot BIT STRING (SIZE (14))
  nrofCandidates SEQUENCE {
  (number of PDCCH cnadidates per aggregation level)
  aggregationLevel1 ENUMERATED {n0, n1, n2, n3, n4, n5,
  n6, n8},
  aggregationLevel2 ENUMERATED {n0, n1, n2, n3, n4, n5,
  n6, n8},
  aggregationLevel4 ENUMERATED {n0, n1, n2, n3, n4, n5,
  n6, n8},
  aggregationLevel8 ENUMERATED {n0, n1, n2, n3, n4, n5,
  n6, n8},
  aggregationLevel16 ENUMERATED {n0, n1, n2, n3, n4, n5,
  n6, n8}
  },
  searchSpaceType CHOICE {
    -- Configures this search space as common search space (CSS) and DCI
    formats to monitor.
    common SEQUENCE {
  (common serach space)
    }
    ue-Specific SEQUENCE {
  (UE-specific serach space)
    -- Indicates whether the UE monitors in this USS for DCI formats 0-0 and 1-0
  or for formats 0-1 and 1-1.
    formats ENUMERATED {formats0-0-And-1-
  0, formats0-1-And-1-1},
    ...
        }
```

Based on the configuration information, the BS may configure the UE with one or more search space sets. According to an embodiment of the disclosure, the BS may configure search space set 1 and search space set 2 for the UE, and may configure the UE to monitor DCI format A scrambled by an X-RNTI in the search space set 1 in the common search space and to monitor DCI format B scrambled by a Y-RNTI in the search space set 2 in the UE-specific search space.

Based on the configuration information, one or more search space sets may be present in the common search space or the UE-specific search space. For example, search space set #1 and search space set #2 may be configured as the common search space, and search space set #3 and search space set #4 may be configured as the UE-specific search space.

The common search space may be classified as particular-type search space sets according to purposes. RNTIs to be monitored may be different according to defined search space set types. For example, common search space types, purposes, and RNTIs to be monitored may be classified as in Table 13 below.

TABLE 13

| Search Space | Purposes | RNTI |
|---|---|---|
| Type0 CSS | PDCCH transmission for | SI-RNTI |
| | SIB scheduling | |
| Type0A CSS | PDCCH transmission for | SI-RNTL |
| | SI (SIB2 etc.) scheduling | |
| | other than SIB1 | |
| Type1 CSS | PDCCH transmission for | RA-RNTI, TC-RNTI |
| | RAR (random access response) | |
| | scheduling , Msg3 | |
| Type2 CSS | Paging | P-RNTI |
| Type3 CSS | transmission of group control | I NT-RNTI , |
| | information | SFI-RNTI, |
| | | TPC PUSCH-RNTI, |
| | | TPC-PUCCH-RNTI, |
| | In a case of PCell, PDCCH | C-RNTI , |
| | transmission for data scheduling | MCS-C-RNTI , |

In the common search space, combinations of DCI formats and RNTIs below may be monitored. Obviously, the combinations are not limited to an example below.
DCI format 0_0/1_0 with CRC scrambled by C-RNTI, CS-RNTI, SP-CSI-RNTI, RA-RNTI. TC-RNTI, P-RNTI, SI-RNT
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-P CCII-RNTI
DCI format 2_3 with CRC scrambled by TPC-SRS-RNTI

In the UE-specific search space, combinations of DCI formats and RNTIs below may be monitored. Obviously, the combinations are not limited to an example below.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

The RNTIs may conform to definitions or purposes below.

C-RNTI (Cell RNTI): for UE-specific PDSCH scheduling

TC-RNTI (Temporary Cell RNTI): for UE-specific PDSCH scheduling

CS-RNTI (Configured Scheduling RNTI): for semi-statically configured UE-specific PDSCH scheduling

RA-RNTI (Random Access RNTI): for PDSCH scheduling in a random access process

P-RNTI (Paging RNTI): for scheduling a PDSCH on which paging is transmitted

SI-RNTI (System Information RNTI): for scheduling a PDSCH on which system information is transmitted

INT-RNTI (Interruption RNTI): for indicating whether to puncture the PDSCH

TPC-PUSCH-RNTI (Transmit Power Control for PUSCH RNTI): for indicating power control command for a PUSCH

TPC-PUCCH-RNTI (Transmit Power Control for PUCCH RNTI): for indicating power control command for a PUCCH

TPC-SRS-RNTI (Transmit Power Control for SRS RNTI): for indicating power control command for an SRS

In an embodiment, the afore-described DCI formats may be defined as in Table 14 below.

TABLE 14

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and |
| | OFDM symbol(s) where UE may assume no |
| | transmission is intended for the UE |
| 2_2 | Transmission of TPC commands for PUCCH |
| | and PUSCH |
| 2_3 | Transmission of a group of TPC commands |
| | for SRS transmissions by one or more UEs |

According to an embodiment of the disclosure, in the 5G system, a plurality of search space sets may be configured with different parameters (e.g., the parameters in Table 12 or Table 13). Therefore, a group of search space sets the UE monitors may be different every time. For example, when the search space set #1 is configured with X-slot periodicity and the search space set #2 is configured with Y-slot periodicity, where X and Y are different, the UE may monitor both the search space set #1 and the search space set #2 in a particular slot, and may monitor one of the search space set #1 and the search space set #2 in another particular slot.

When a plurality of search space sets are configured for the UE, the UE may consider conditions below to determine a search space set to monitor.

[Condition 1: Restriction on Maximum Number of PDCCH Candidates]

The number of PDCCH candidates to be monitored per slot may not exceed M^{μ}. M^{μ} may be defined as a maximum number of PDCCH candidates per slot in a cell configured with subcarrier spacing of 15·2^{μ} kHz, and may be defined as in Table 15 below.

TABLE 15

| | Maximum number of monitored PDCCH candidates |
|---|---|
| μ | per slot and per serving cell M_{PDCCH}^{max,slot,μ} |
| 0 | 44 |
| 1 | 36 |
| 2 | 22 |
| 3 | 20 |

[Condition 2: Restriction on Maximum Number of CCEs]

The number of CCEs constitute the whole search spaces (here, the whole search spaces refer to a whole CCE set corresponding to a union region of a plurality of search space sets) per slot may not exceed C^{μ}. C^{μ} may be defined as a maximum number of CCEs per slot in a cell configured with subcarrier spacing of 15·2^{μ} kHz, and may be defined as in Table 16 below.

TABLE 16

| | Maximum number of non-overlapped CCEs per |
|---|---|
| μ | slot and per serving cell C_{PDCCH}^{max,slot,μ} |
| 0 | 56 |
| 1 | 56 |
| 2 | 48 |
| 3 | 32 |

For convenience of descriptions, a situation that satisfies both conditions 1 and 2 at a particular time is defined as “condition A” as an example. Accordingly, failing to satisfy the condition A may mean that at least one of the condition 1 or the condition 2 is not satisfied.

A case where the condition A is not satisfied at a particular time according to configuration of the search space sets by the BS may occur. When the condition A is not satisfied at the particular time, the UE may select and monitor only some of the search space sets configured to satisfy the condition A at the particular time, and the BS may transmit a PDCCH in the selected search space set.

According to an embodiment of the disclosure, in order to select some search spaces among all of the configured search space sets, a method below may be performed.

[Method 1]

In a case where the condition A for the PDCCH is not satisfied at a particular time (or slot), the UE (or the BS) may priorly select a search space set whose search space type is configured as the common search space over a search space set that is configured as the UE-specific search space, from among the search space sets that exist at the particular time.

When all the search space sets configured as the common search space are selected (i.e., when the condition A is satisfied even after all the search space sets configured as the common search space are selected), the UE (or the BS) may select search space sets configured as the UE-specific space. Here, when there are a plurality of search space sets configured as the UE-specific search space, a search space set having a lower search space index may have higher priority. In consideration of the priorities, the UE (or the BS) may select UE-specific search space sets within a range in which they satisfy the condition A.

Hereinafter, methods of allocating time and frequency resources for data transmission in an NR system will now be described.

In the NR system, in addition to frequency-domain resource candidate allocation via BWP indication, frequency domain resource allocation (FD-RA) methods below may be provided.

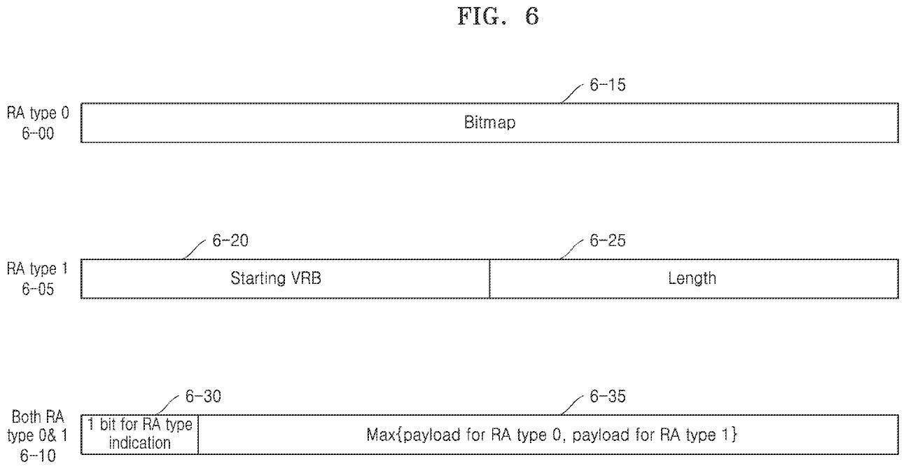

FIG. 6 is a diagram illustrating an example of PDSCH frequency-domain resource allocation in a wireless communication system according to an embodiment of the disclosure.

In more detail, FIG. 6 is a diagram illustrating three frequency-domain resource allocation methods, which are type 0 6-00, type 1 6-05, and dynamic switching 6-10, which are configurable by higher layer signaling in the NR system.

Referring to FIG. 6, when the UE is configured, by higher layer signaling, to use only resource type 0 (6-00), some DCI to allocate a PDSCH to the UE has a bitmap consisting of NRBG bits. Conditions for the above will be described at a later time.

Here, NRGB refers to the number of resource block groups (RBGs) determined as in Table 17 below according to a size of a BWP allocated by the BWP indicator and an upper layer parameter rbg-Size, and data is transmitted on an RBG represented by 1 based in the bitmap.

TABLE 17

| Bandwidth | | |
|---|---|---|
| Part Size | Configuration 1 | Configuration 2 |
| 1-36 | 2 | 4 |
| 37-72 | 4 | 8 |
| 73-144 | 8 | 16 |
| 145-275 | 16 | 16 |

When the UE is configured, by higher layer signaling, to use only resource type 1 (6-05), some DCI to allocate a PDSCH to the UE has frequency-domain resource allocation information consisting of

$$⌈ {log}_{2} ( \frac{{N}_{RB}^{DL , BWP} ( {N}_{RB}^{DL , BWP} + 1 )}{2} ) ⌉$$

bits.

Conditions for the above will be described at a later time. The BS may configure a starting virtual resource block (VRB) 6-20 and length of frequency-domain resources 6-25 successively allocated from the starting VRB 6-20.

If the UE is configured, by higher layer signaling, to use both the resource type 0 and the resource type 1 (6-10), some DCI to allocate a PDSCH to the UE has frequency-domain resource allocation information consisting of bits 6-35 corresponding to a larger value among a payload 6-15 for configuring the resource type 0 and a payloads 6-20 and 6-25 for configuring the resource type 1. Conditions for the above will be described at a later time. In this case, 1 bit may be added to the most significant bit (MSB) of the frequency-domain allocation information in the DCI, and when the bit is 0, it indicates that the resource type 0 is to be used, and when the bit is 1, it indicates that the resource type 1 is to be used.

Hereinafter, a time domain resource allocation method for a data channel in the next-generation wireless communication system (5G or NR system) will now be described.

The BS may configure the UE with Table of time domain resource allocation information for a DL data channel (PDSCH) and a UL data channel (PUSCH) by higher layer signaling (e.g., RRC signaling). For the PDSCH, Table including up to 16 (maxNrofDL-Allocations=16) entries may be configured, and for the PUSCH, Table including up to 16 (maxNrofUL-Allocations=16) entries may be configured. In an embodiment, the time domain resource allocation information may include PDCCH-to-PDSCH slot timing (corresponding to a time interval in slots between a reception time of PDCCH and a transmission time of PDSCH scheduled by the received PDCCH, and indicated as K0), PDCCH-to-PUSCH slot timing (corresponding to a time interval in slots between a reception time of PDCCH and a transmission time of PUSCH scheduled by the received PDCCH, and indicated as K2), information about location and length of a start symbol scheduled on the PDSCH or the PUSCH in the slot, a mapping type of PDSCH or PUSCH, or the like. For example, a plurality of pieces of information as in Table 18 or Table 19 below may be notified from the BS to the UE.

TABLE 18

```
      PDSCH-TimeDomainResourceAllocationList information element
PDSCH-TimeDomainResourceAllocationList ::= SEQUENCE
(SIZE(1..maxNrofDL-Allocations) ) OF PDSCH-
TimeDomainResourceAllocation
PDSCH-TimeDomainResourceAllocation ::= SEQUENCE {
    k0  INTEGER(0..32)
OPTIONAL,   -- Need S
(PDCCH-to-PDSCH timing, slot unit)
    mappingType ENUMERATED {typeA, typeB},
(PDSCH mapping type)
    startSymbolAndLength INTEGER (0..127)
(start symbol and length of PDSCH)
}
```

TABLE 19

```
        PUSCH-TimeDomainResourceAllocation information element
PUSCH-TimeDomainResourceAllocationList :: = SEQUENCE
(SIZE (1..maxNrofUL-Allocations) ) OF PUSCH-
TimeDomainResourceAllocation
PDSCH-TimeDomainResourceAllocation ::=  SEQUENCE {
  k2 INTEGER (0..32)
OPTIONAL,  -- Need S
(PDCCH-to-PUSCH timing, slot unit)
    mappingType ENUMERATED {typeA, typeB} ,
(PUSCH mapping type)
    startSymbolAndLength INTEGER (0..127)
(start symbol and length of PDSCH)
}
```

The BS may notify the UE of at least one of the entries in Table about the time-domain resource allocation information by L1 signaling (e.g., the one entry may be indicated in a ‘time domain resource allocation’ field in the DCI). The UE may obtain the time domain resource allocation information for the PDSCH or the PUSCH, based on the DCI received from the BS.

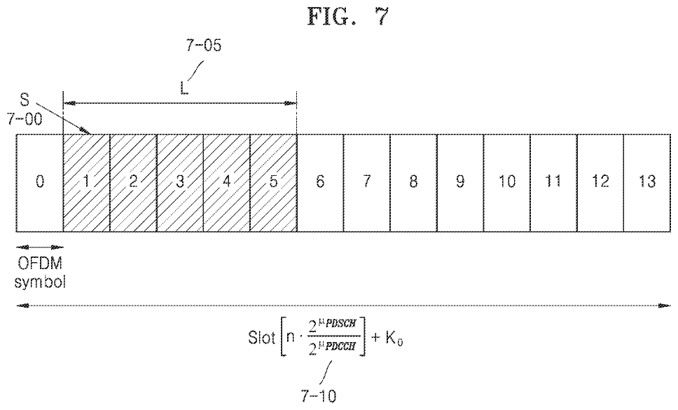

FIG. 7 is a diagram illustrating an example of PDSCH time-domain resource allocation in a wireless communication system according to an embodiment of the disclosure.

Referring to FIG. 7, the BS may indicate a position of a PDSCH resource in the time domain based on subcarrier spacings (SCSs) (μ_{PDSCH}, μ_{PDCCH}) of a data channel and a control channel and a scheduling offset K₀, which are configured by using higher layer signaling, and a start position 7-00 and length 7-05 of OFDM symbols in a slot dynamically indicated in DCI.

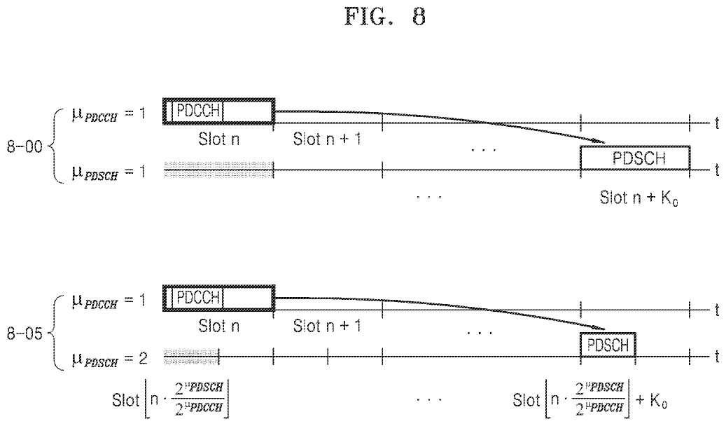

FIG. 8 is a diagram illustrating an example of time-domain resource allocation based on SCSs of a data channel and a control channel in a wireless communication system according to an embodiment of the disclosure.

Referring to FIG. 8, when SCSs of the data channel and the control channel are equal, i.e., μ_{PDSCH}=μ_{PDCCH}|(8-00), slot numbers for data and control are equal, such that the BS and the UE may identify occurrence of a scheduling offset according to the preset slot offset K₀. On the other hand, when SCSs of the data channel and the control channel are different, i.e., μ_{PDSCH}≠μ_{PDCCH} (8-05), slot numbers for data and control are different, such that the BS and the UE may identify occurrence of a scheduling offset according to the preset slot offset K₀ based on the SCS of the PDCCH.

In the NR system, when the BS schedules a PDSCH to the UE by using DCI format 1_0 or DCI format 1_1, the UE may transmit hybrid automatic repeat request (HARQ)-acknowledgement (ACK) feedback information about the PDSCH to the BS on a physical uplink control channel (PUCCH). The BS may indicate a slot in which the PUCCH for transmission of the HARQ-ACK feedback information is mapped and a type of a PUCCH resource, to the UE by DCI scheduling the PDSCH. In more detail, the BS may indicate a slot offset between the PDSCH and the PUCCH for transmission of the HARQ-ACK feedback information via a PDSCH-to-HARQ_feedback timing indicator of the DCI that schedules the PDSCH. Also, the BS may indicate a type of the PUCCH resource for transmission of the HARQ-ACK feedback information, via a PUCCH resource indicator of the DCI that schedules the PDSCH.

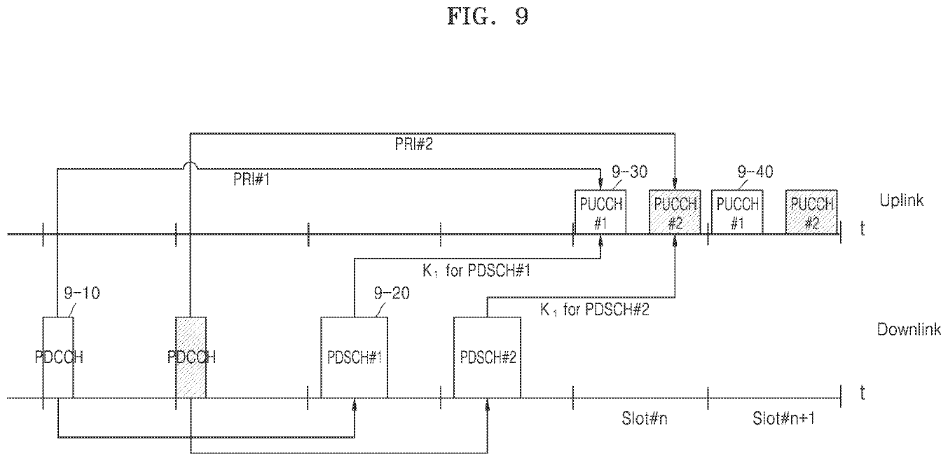

FIG. 9 is a diagram illustrating an example of PUCCH resource allocation for HARQ-ACK feedback according to some embodiments.

Referring to FIG. 9, when a PDSCH 9-20 is scheduled based on DCI information of a PDCCH 9-10, from the BS to the UE, the PDSCH 9-20 is transmitted, and information of a slot in which a PUCCH 9-30 including HARQ-ACK feedback corresponding to the PDSCH 9-20 is mapped and mapping information of a symbol in the slot of the PUCCH 9-30 including HARQ-ACK feedback are delivered. In more detail, the BS may indicate a slot interval K₁ between a PDSCH and HARQ-ACK feedback corresponding thereto to the UE via a PDSCH-to-HARQ_feedback timing indicator. Also, the BS may indicate, to the UE, a candidate value of a slot interval by higher layer signaling or one of eight feedback timing offsets which are predefined from 1 to 8. Also, the BS may indicate, to the UE, one of eight resources configured by higher layer signaling via a PUCCH resource indicator, so as to deliver a PUCCH-format to which HARQ-ACK feedback information is to be mapped, and a PUCCH resource including a position of a start symbol, and the number of mapping symbols. The UE determines a time-domain mapping position of the PUCCH including HARQ-ACK feedback by referring to a slot interval between the PDSCH and HARQ-ACK feedback corresponding thereto, and a position of a start symbol and the number of mapping symbols which are configured for the PUCCH resource. Also, the UE may map HARQ-ACK feedback information according to the PUCCH-format configured for the PUCCH resource. If PUCCH repetition transmission is configured, the UE may repeatedly transmit a same PUCCH resource over n consecutive slots, and the n may be configured by higher layer signaling. For example, when n=2, the UE may transmit the PUCCH 9-30 in a slot of a same PUCCH resource indicated by using the PDSCH-to-HARQ_feedback timing indicator, and may repeatedly transmit a PUCCH 9-40 in a slot immediately after the slot described above.

A spatial domain transmission filter of the UE that transmits a PUCCH follows spatial relation info of the PUCCH which is activated on the PUCCH resource by higher layer signaling including an MAC CE. When the activated spatial relation info of the PUCCH resource refers to a CSI-RS resource or an index of a SS/PBCH block (SSB), the UE may transmit the PUCCH by using a same spatial domain transmission filter as a spatial domain receive filter used in reception of the referenced CSI-RS resource or SSB. Alternatively, when the activated spatial relation info of the PUCCH resource refers to a sounding reference signal (SRS) resource index, the UE may transmit the PUCCH by using a spatial domain transmission filter used in transmission of the referenced SRS resource.

Hereinafter, a UL channel estimation method using SRS transmission of the UE will now be described. The BS may configure the UE with at least one SRS configuration for each UL BWP so as to transmit configuration information for SRS transmission, and may configure the UE with at least one SRS resource set for each SRS configuration. For example, the BS and the UE may exchange signaling information to deliver information about the SRS resource set.
srs-ResourceSetId: SRS resource set index
srs-ResourceldList: a set of SRS resource indexes referred to from the SRS resource set
resourceType: time-domain transmission configuration of an SRS resource referred to from the SRS resource set, which may be configured to one of ‘periodic’, ‘semi-persistent’, and ‘aperiodic’. If resourceType is configured to ‘periodic’ or ‘semi-persistent’, associated CSI-RS information may be provided according to the usage of the SRS resource set. If resourceType is configured to ‘aperiodic’, an aperiodic SRS resource trigger list and slot offset information may be provided, and associated CSI-RS information may be provided according to the usage of the SRS resource set.
usage: configuration of the usage of an SRS resource referred to from the SRS resource set, which may be configured to one of ‘beamManagement’, ‘codebook’, ‘nonCodebook’, and ‘antennaSwitching’.
alpha, p0, pathlossReferenceRS, srs-PowerControlAdjustmentStates: provides parameter configuration for transmission power control for an SRS resource referred to from the SRS resource set.

The UE may determine that an SRS resource included in a set of SRS resource indexes referred to from the SRS resource set follows information configured for the SRS resource set.

Also, the BS and the UE may transmit or receive higher layer signaling information for delivering individual configuration information for an SRS resource. For example, the individual configuration information for the SRS resource may include time-frequency domain mapping information in a slot of the SRS resource, and the time-frequency domain mapping information may include information about intra-slot or inter-slot frequency hopping of the SRS resource. Furthermore, the individual configuration information for the SRS resource may include time-domain transmission configuration for the SRS resource, which may be configured to one of ‘periodic’, ‘semi-persistent’, and ‘aperiodic’. The individual configuration information for the SRS resource may be limited to having the same time-domain transmission configuration as the SRS resource set including the SRS resource. When the time-domain transmission configuration for the SRS resource is configured to ‘periodic’ or ‘semi-persistent’, the individual configuration information for the SRS resource may additionally include SRS resource transmission periodicity and slot offset (e.g., periodicityAndOffset). The BS may activate or deactivate, or trigger SRS transmission to the UE by higher layer signaling including RRC signaling or MAC CE signaling, or L1 signaling (e.g., DCI).

For example, the BS may activate or deactivate periodic SRS transmission to the UE by higher layer signaling. The BS may indicate activation of an SRS resource set for which resourceType is configured to ‘periodic’ by higher layer signaling, and the UE may transmit an SRS resource referred to from the activated SRS resource set. Time-frequency domain resource mapping of the SRS resource to be transmitted in a slot follows resource mapping information configured for the SRS resource, and slot mapping including transmission periodicity and slot offset follows periodicityAndOffset configured for the SRS resource. Furthermore, the UE may refer to spatial relation info configured for the SRS resource so as to determine a spatial domain transmission filter to be applied to the SRS resource to be transmitted, or may refer to associated CSI-RS information configured for the SRS resource set including the SRS resource. The UE may transmit the SRS resource in a UL BWP activated for the periodic SRS resource activated by higher layer signaling.

For example, the BS may activate or deactivate semi-persistent SRS transmission to the UE by higher layer signaling. The BS may indicate activation of an SRS resource set by MAC CE signaling, and the UE may transmit an SRS resource referred to from the activated SRS resource set. The SRS resource set activated by MAC CE signaling may be limited to an SRS resource set for which the resourceType is configured to ‘semi-persistent’. Intra-slot time-frequency domain resource mapping of the SRS resource to be transmitted follows resource mapping information configured for the SRS resource, and slot mapping including transmission periodicity and slot offset follows periodicityAndOffset configured for the SRS resource. Also, the UE may refer to spatial relation info configured for the SRS resource so as to determine a spatial domain transmission filter to be applied to the SRS resource to be transmitted or may refer to associated CSI-RS information configured for the SRS resource set including the SRS resource. If spatial relation info is configured for the SRS resource, the UE may determine the spatial domain transmission filter by referring to configuration information about spatial relation info delivered by MAC CE signaling that activates semi-persistent SRS transmission. The UE may transmit the SRS resource in a UL BWP activated for the semi-persistent SRS resource activated by higher layer signaling.

For example, the BS may trigger aperiodic SRS transmission to the UE by DCI. The BS may indicate one of aperiodic SRS resource triggers via an SRS request field of the DCI. The UE may determine that an SRS resource set including the aperiodic SRS resource trigger indicated by the DCI in an aperiodic SRS resource trigger list among configuration information of the SRS resource set has been triggered. The UE may transmit an SRS resource referred to from the triggered SRS resource set. Intra-slot time-frequency domain resource mapping of the SRS resource to be transmitted follows resource mapping information configured for the SRS resource. Also, slot mapping of the SRS resource to be transmitted may be determined by a slot offset between a PDCCH including the DCI and the SRS resource, and a value (or values) included in a slot offset set configured for the SRS resource set may be referred to as the slot offset. In more detail, for the slot offset between the PDCCH including the DCI and the SRS resource, the UE may apply a value indicated by a time domain resource assignment field of the DCI among offset value(s) included in the slot offset set configured for the SRS resource set. Furthermore, the UE may refer to spatial relation info configured for the SRS resource so as to determine a spatial domain transmission filter to be applied to the SRS resource to be transmitted or may refer to associated CSI-RS information configured for the SRS resource set including the SRS resource. The UE may transmit the SRS resource in a UL BWP activated for the aperiodic SRS resource triggered by the DCI.

When the BS triggers aperiodic SRS transmission to the UE by DCI, a minimum time interval between a PDCCH including the DCI that triggers the aperiodic SRS transmission and an SRS to be transmitted may be required for the UE to transmit the SRS by applying configuration information for the SRS resource. The time interval for SRS transmission by the UE may be defined as the number of symbols between a last symbol of the PDCCH including the DCI that triggers the aperiodic SRS transmission and a first symbol to which a SRS resource to be initially transmitted among SRS resource(s) is mapped. The minimum time interval may be determined by referring to a PUSCH preparation procedure time required for the UE to prepare PUSCH transmission. Also, the minimum time interval may have a different value according to the usage of the SRS resource set including the SRS resource to be transmitted. For example, the minimum time interval may be determined to be N₂ symbols defined by referring to a PUSCH preparation procedure time of the UE and considering a UE processing capability based on the UE capability. Also, when the usage of the SRS resource set is configured to ‘codebook’ or ‘antennaSwitching’ by considering the usage of the SRS resource set including the SRS resource to be transmitted, the UE may determine the minimum time interval to be N₂ symbols, and when the usage of the SRS resource set is configured to ‘nonCodebook’ or ‘beamManagement’, the UE may determine the minimum time interval to be N₂+14 symbols. When the time interval for aperiodic SRS transmission is equal to or greater than the minimum time interval, the UE may transmit an aperiodic SRS, and when the time interval for aperiodic SRS transmission is smaller than the minimum time interval, the UE may ignore the DCI that triggers the aperiodic SRS.

TABLE 20

```
SRS-Resource ::=  SEQUENCE {
    srs-ResourceId  SRS-ResourceId,
    nrofSRS-Ports  ENUMERATED {port1,
ports2, ports4},
    ptrs-PortIndex  ENUMERATED {n0, n1 }
OPTIONAL, -- Need R
    transmissionComb  CHOICE {
        n2 SEQUENCE {
            combOffset-n2  INTEGER
(0..1),
            cyclicShift-n2 INTEGER
(0..7)
        },
        n4 SEQUENCE {
            CombOffset-n4  INTEGER
(0..3),
            cyclicShift-n4 INTEGER
(0..11)
        }
    },
    resourceMapping  SEQUENCE {
        startPosition  INTEGER (0..5),
        nrofSymbols  ENUMERATED {n1,
n2, n4),
        repetitionFactor  ENUMERATED {n1,
n2, n4}
    },
    freqDomainPosition  INTEGER (0..67),
    freqDomainShift  INTEGER (0..268),
    freqHopping  SEQUENCE {
        c-SRS  INTEGER (0..63),
        b-SRS  INTEGER (0..3),
        b-hop  INTEGER (0..3)
    },
    groupOrSequenceHopping  ENUMERATED {
neither, groupHopping, sequenceHopping },
    resourceType CHOICE {
        aperiodic SEQUENCE {
            ...
        },
        semi-persistent  SEQUENCE {
            periodicityAndOffset-sp SRS
PeriodicityAndOffset,
            ...
        },
        periodic  SEQUENCE {
            periodicityAndOffset-p  SRS-
PeriodicityAndOffset,
            ...
        }
    },
    sequenceId  INTEGER (0..1023),
    spatialRelationInfo  SRS-
SpatialRelationInfo  OPTIONAL,
-- Need R
    ...
}
```

Configuration information of spatialRelationInfo in Table 20 above is to refer to one reference signal and apply beam information of the reference signal to a beam to be used for the SRS transmission. For example, the configuration of spatialRelationInfo may include information as in Table 21 below.

TABLE 21

```
SRS-SpatialRelationInfo ::= SEQUENCE {
    servingCellId  ServCellIndex
OPTIONAL,  -- Need S
    referenceSignal  CHOICE {
        ssb-Index  SSB-Index,
        csi-RS-Index  NZP-CSI-RS-
ResourceId,
        srs SEQUENCE {
            resourceId SRS-ResourceID,
            uplinkBWP BWP-Id
        }
    }
}
```

Referring to the spatialRelationInfo configuration, in order to use beam information of a particular reference signal, an SS/PBCH block index, a CSI-RS index or an SRS index may be configured as an index of a reference signal to be referred to. Higher layer signaling referenceSignal is configuration information indicating which beam information of a reference signal is to be referred to for the SRS transmission, and ssb-index refers to an index of an SS/PBCH, csi-RS-index refers to an index of a CSI-RS, and srs refers to an index of an SRS. If a value of the higher layer signaling referenceSignal is configured to ‘ssb-Index’, the UE may apply a reception beam, which has been used to receive an SS/PBCH block corresponding to the ssb-index, to a transmission beam for corresponding SRS transmission. If a value of the higher layer signaling referenceSignal is configured to ‘csi-RS-Index’, the UE may apply a reception beam, which has been used to receive a CSI-RS corresponding to the csi-RS-index, to a transmission beam for corresponding SRS transmission. If a value of the higher layer signaling referenceSignal is configured to ‘srs’, the UE may apply a transmission beam, which has been used to transmit an SRS corresponding to the srs, to a transmission beam for corresponding SRS transmission.

Hereinafter, a PUSCH transmission scheduling scheme will now be described. PUSCH transmission may be dynamically scheduled by UL grant in DCI or may be operated by configured grant Type 1 or Type 2. Dynamic scheduling indication for PUSCH transmission may be indicated by DCI format 0_0 or 0_1. Configured grant Type 1 PUSCH transmission may be semi-statically configured not by receiving UL grant in DCI but by receiving configuredGrantConfig including rrc-ConfiguredUplinkGrant of Table 22 below by higher layer signaling. Configured grant Type 2 PUSCH transmission may be semi-persistently scheduled by UL grant in DCI after receiving configuredGrantConfig that does not include rrc-ConfiguredUplinkGrant of Table 22 by higher layer signaling. When the PUSCH transmission is operated by configured grant, parameters to be applied to the PUSCH transmission are applied by higher layer signaling configuredGrantConfig of Table 22 except for dataScramblingldentityPUSCH, txConfig, codebookSubset, maxRank, scaling of UCI-OnPUSCH provided by higher layer signaling that is pusch-Config of Table 23. When the UE receives transformPrecoder in higher layer signaling that is configuredGrantConfig of Table 22, the UE applies tp-pi2BPSK in pusch-Config that is higher layer signaling of Table 23 to the PUSCH transmission operated by the configured grant.

TABLE 22

```
ConfiguredGrantConfig ::=  SEQUENCE {
    frequencyHopping  ENUMERATED {intraSlot,
interSlot}  OPTIONAL, --
Need S,
    cg-DMRS-Configuration DMRS-UplinkConfig,
    mcs-Table  ENUMERATED {qam256,
qam64LowSE }  OPTIONAL,
-- Need S
    mcs-TableTransformPrecoder ENUMERATED {qam256,
qam64LowSE }  OPTIONAL,
-- Need S
    uci-OnPUSCH SetupRelease { CG-UCI-
OnPUSCH }  OPTLONAL, --
Need M
    resourceAllocation  ENUMERATED {
resourceAllocationType0, resourceAllocationType1, dynamicSwitch
},
    rbg-Size  ENUMERATED {config2}
OPTIONAL, -- Need S
    powerControlLoopToUse ENUMERATED {n0, n1},
    p0-PUSCH-Alpha P0-PUSCH-AlphasetId,
    transformPrecoder  ENUMERATED {enabled,
disabled}  OPTIONAL, -
- Need S
    nrofHARQ-Processes INTEGER (1..16),
    repK ENUMERATED {n1, n2, n4,
n8},
    repK-RV ENUMERATED {s1-0231, s2-
0303, s3-0000} OPTIONAL, --
Need R
    periodicity ENUMERATED {
                                                  sym2, sym7,
sym1x14, sym2x14, sym4x14, sym5x14, sym8x14, sym10x14, sym16x14,
sym20x14,
                                                  sym32x14,
sym40x14, sym64x14, sym80x14, sym128x14, sym160x14, sym256x14,
sym320x14, sym512x14,
                                                  sym640x14,
sym1024x14, sym1280x14, sym2560x14, sym5120x14,
                                                  sym6, sym1x12.
sym2x12, sym4x12, sym5x12, sym8x12, sym10x12, sym16x12,
sym20x12, sym32x12,
                                                  sym40x12,
sym64x12, sym80x12, sym128x12, sym160x12, sym256x12, sym320x12,
sym512x12, sym640x12,
                                                  sym1280x12,
sym2560x12
    },
    configuredGrantTimer INTEGER (1..64)
OPTIONAL, -- Need R
    rrc-ConfiguredUplinkGrant SEQUENCE {
        timeDomainOffset INTEGER
(0..5119),
        timeDomainAllocation INTEGER
(0..15),
        frequencyDomainAllocation BIT STRING
(SIZE (18) ),
        antennaPort INTEGER (0..31),
        dmrs-SeqInitialization INTEGER (0..1)
OPTIONAL,  -- Need R
        precodingAndNumberOfLayers INTEGER (0..63),
        srs-ResourceIndicator INTEGER (0..15)
OPTIONAL,   -- Need R
        msAndTBS INTEGER (0..31),
        frequencyHoppingOffset INTEGER (1..
maxNrofPhysicalResourceBlocks-1)  OPTIONAL,   -
- Need R
        pathlossReferenceIndex  INTEGER
(0. .maxNrofPUSCH-PathlossReferenceRSs-1),
        ...
    }
OPTIONAL,  -- Need R
    ...
}
```

Hereinafter, a PUSCH transmission method will now be described. An antenna port for PUSCH transmission is equal to an antenna port for SRS transmission. PUSCH transmission may follow a codebook based transmission method or a non-codebook based transmission method depending on whether a value of txConfig in higher layer signaling that is pusch-Config of Table 23 is ‘codebook’ or ‘nonCodebook’. As described above, PUSCH transmission may be dynamically scheduled by DCI format 0_0 or 0_1, or may be semi-statically configured by the configured grant. If the UE receives an indication of scheduling of PUSCH transmission by DCI format 0_0, the UE performs beam configuration for PUSCH transmission by using pucch-spatialRelationInfoID corresponding to a UE-specific PUCCH resource corresponding to a smallest ID in an activated UL BWP in the serving cell, and in this regard, the PUSCH transmission is based on a single antenna port. The UE does not expect scheduling for the PUSCH transmission by DCI format 0_0 in a BWP on which a PUCCH resource including pucch-spatialRelationInfo is not configured. If the UE is not configured with txConfig in the pusch-Config that is higher layer signaling of Table 23, the UE does not expect to be scheduled by DCI format 0_1.

TABLE 23

```
PUSCH-Config ::=  SEQUENCE {
    dataScramblingIdentityPUSCH  INTEGER ( 0..1023)
OPTIONAL,   -- Need S
    txConfig  ENUMERATED
{codebook, nonCodebook}
OPTIONAL,   -- Need S
    dmrs-UplinkForPUSCH-MappingTypeA  SetupRelease { DMRS-
UplinkConfig }  OPTIONAL,  --
Need M
    dmrs-UplinkForPUSCH-MappingTypeB  SetupRelease { DMRS-
UplinkConfig }  OPTLONAL,  --
Need M
    pusch-PowerControl  PUSCH-PowerControl
OPTIONAL,   -- Need M
    frequencyHopping  ENUMERATED
{intraSlot, interSlot}
OPTIONAL,   -- Need S
    frequencyHoppingOffsetLists  SEQUENCE (SIZE
(1..4)) OF INTEGER (1.. maxNrofPhysicalResourceBlocks-1)
OPTIONAL,   -- Need M
    resourceAllocation  ENUMERATED {
resourceAllocationType0, resourceAllocationType1,
dynamicswitch},
    pusch-TimeDomainAllocationList  SetupRelease {
PUSCH-TimeDomainResourceAllocationList } OPTIONAL,
-- Need M
    pusch-AggregationFactor  ENUMERATED { n2, n4,
n8 }  OPTIONAL,  --
Need S
    mcs-Table  ENUMERATED {qam256,
qam64LowSE}  OPTIONAL,  --
Need S
    mcs-TableTransformPrecoder  ENUMERATED {qam256,
qam64LowSE}  OPTIONAL,  --
Need S
    transformPrecoder  ENUMERATED {enabled,
disabled}  OPTIONAL,  --
Need S
    codebookSubset  ENUMERATED
{fullyAndPartialAndNonCoherent,
partialAndNonCoherent, noncoherent}
OPTIONAL, -- Cond codebookBased
    maxRank  INTEGER (1..4)
OPTIONAL, -- Cond codebookBased
    rbg-Size  ENUMERATED {
config2 }  OPTIONAL, -- Need S
    uci-OnPUSCH  SetupRelease { UCI-
OnPUSCH}  OPTIONAL, -- Need M
    tp-pi2BPSK  ENUMERATED {enabled}
OPTIONAL, -- Need S
    ...
}
```

Hereinafter, codebook based PUSCH transmission will now be described. Codebook based PUSCH transmission may be dynamically scheduled by DCI format 0_0 or 0_1, or may be semi-statically operated by the configured grant. When the codebook based PUSCH transmission is dynamically scheduled by DCI format 0_1 or semi-statically configured by the configured grant, the UE determines a precoder for PUSCH transmission based on an SRS resource indicator (SRI), a transmission precoding matrix indicator (TPMI), and a transmission rank. Here, the SRI may be given by an SRS resource indicator that is a field in DCI or may be configured by srs-ResourceIndicator that is higher layer signaling. The UE may be configured with at least one SRS resource for codebook based PUSCH transmission, and may be configured with up to two SRS resources. When the UE receives the SRI by DCI, an SRS resource indicated by the SRI refers to an SRS resource corresponding to the SRI among SRS resources transmitted before the PDCCH including the SRI.

Also, the TPMI and the transmission rank may be given by precoding information and number of layers that is a field in the DCI or may be configured by precodingAndNumberOfLayers that is higher layer signaling. The TPMI is used to indicate a precoder to be applied to PUSCH transmission. If the UE is configured with one SRS resource, the TPMI is used to indicate a precoder to be applied in the configured one SRS resource. If the UE is configured with a plurality of SRS resources, the TPMI is used to indicate a precoder to be applied in the SRS resource indicated by the SRI. The precoder to be used in PUSCH transmission is selected from a UL codebook having the same number of antenna ports as a value of nrofSRS-Ports in SRS-Config that is higher layer signaling.

In the codebook based PUSCH transmission, the UE determines a codebook subset based on the TPMI and codebookSubset in pusch-Config that is higher layer signaling. The codebookSubset in the pusch-Config that is higher layer signaling may be configured as one of ‘fullyAndPartialAndNonCoherent’, ‘partialAndNonCoherent’, and ‘nonCoherent’, based on the UE capability reported by the UE to the BS. If the UE reports ‘partialAndNonCoherent’ in the UE capability, the UE does not expect that a value of codebookSubset that is higher layer signaling is configured to be ‘fullyAndPartialAndNonCoherent’. If the UE reports ‘nonCoherent’ in the UE capability, the UE does not expect that a value of codebookSubset that is higher layer signaling is configured to be ‘fullyAndPartialAndNonCoherent’ or ‘partialAndNonCoherent’. When nrofSRS-Ports in SRS-ResourceSet that is higher layer signaling indicates two SRS antenna ports, the UE does not expect that a value of codebookSubset that is higher layer signaling is configured to be ‘partialAndNonCoherent’. The UE may be configured with one SRS resource set with a value of the usage in SRS-ResourceSet that is higher layer signaling being configured to ‘codebook’, and one SRS resource in the SRS resource set may be indicated by the SRI. If several SRS resources are configured in the SRS resource set in which a value of the usage in SRS-ResourceSet that is higher layer signaling is configured to ‘codebook’, the UE expects that nrofSRS-Ports in SRS-Resource that is higher layer signaling is configured to have the same value for all SRS resources.

Hereinafter, non-codebook based PUSCH transmission will now be described. Non-codebook based PUSCH transmission may be dynamically scheduled by DCI format 0_0 or 0_1, or semi-statically operated by the configured grant. When at least one SRS resource in an SRS resource set in which a value of the usage in SRS-ResourceSet that is higher layer signaling is configured to ‘nonCodebook’ is configured, the UE may be scheduled for non-codebook based PUSCH transmission by DCI format 0_1.

For the SRS resource set with a value of the usage in SRS-ResourceSet that is higher layer signaling being configured to ‘nonCodebook’, the UE may be configured with one associated non-zero power CSI-RS (NZP CSI-RS) resource. The UE may perform calculation on a precoder for SRS transmission by measuring the NZP CSI-RS resource associated with the SRS resource set. If a difference between a last reception symbol of an aperiodic NZP CSI-RS resource associated with the SRS resource set and a first symbol of aperiodic SRS transmission from the UE is less than 42 symbols, the UE does not expect that information about the precoder for SRS transmission is to be updated.

When a value of resourceType in SRS-ResourceSet that is higher layer signaling is configured to ‘aperiodic’, an associated NZP CSI-RS is indicated by the field SRS request in DCI format 0_1 or 1_1. Here, when the associated NZP CSI-RS resource is an aperiodic NZP CSI-RS resource, it indicates existence of an NZP CSI-RS associated for a case where the value of the field SRS request in DCI format 0_1 or 1_1 is not ‘00’. Here, the DCI shall not indicate cross carrier or cross BWP scheduling. Also, if the existence of the NZP CSI-RS is indicated, the NZP CSI-RS is located in a slot in which a PDCCH including the SRS request field is transmitted. Here, TCI states configured for a scheduled subcarrier are not configured to QCL-TypeD. If a periodic or semi-persistent SRS resource set is configured, an associated NZP CSI-RS may be indicated by associatedCSI-RS in SRS-ResourceSet that is higher layer signaling. For non-codebook based transmission, the UE does not expect both the spatialRelationInfo that is higher layer signaling for an SRS resource and associatedCSI-RS in the SRS-ResourceSet that is higher layer signaling to be configured.

When the UE is configured with a plurality of SRS resources, the UE may determine a precoder and a transmission rank to be applied to PUSCH transmission, based on the SRI indicated by the BS. Here, the SRI may be indicated by a SRS resource indicator that is a field in DCI or may be configured by srs-ResourceIndicator that is higher layer signaling. Likewise, in regard to the codebook based PUSCH transmission, when the UE is provided the SRI by DCI, an SRS resource indicated by the SRI refers to an SRS resource corresponding to the SRI among SRS resources transmitted before the PDCCH including the SRI. The UE may use one or more SRS resources in SRS transmission, and a maximum number of SRS resources available for simultaneous transmission on the same symbol in one SRS resource set and a maximum number of SRS resources are determined based on UE capability reported by the UE to the BS. In this case, the SRS resources simultaneously transmitted by the UE occupy a same RB. The UE configures one SRS port for each SRS resource. Only one SRS resource set with a value of the usage in SRS-ResourceSet that is higher layer signaling is configured to ‘nonCodebook’ may be configured, and up to four SRS resources for non-codebook based PUSCH transmission may be configured.

Hereinafter, a PUSCH preparation procedure time will now be described. When the BS schedules the UE to transmit a PUSCH by using DCI format 0_0 or DCI format 0-1, the UE may need a PUSCH preparation procedure time to transmit the PUSCH by applying a transmission method (an SRS resource transmission precoding method, the number of transmission layers, or a spatial domain transmission filter) indicated by DCI. In consideration of information above, NR defines a PUSCH preparation procedure time. The PUSCH preparation procedure time of the UE may be calculated by using Equation 1 below.

T_{proc,2}=max((N₂+d_{2,1})(2048+144)·κ2^{-μ}·T_{c}d_{2,2}) [Equation 1]

Each of variables in T_{proc,2} above may have the following meanings.
N₂: the number of symbols determined according to UE processing capability 1 or 2 and numerology μ. When the UE capability 1 is reported in a UE capability report, it may have a value based on Table 24, and when the UE capability 2 is reported in the UE capability report and when it is configured, by higher layer signaling, that the UE capability 2 is available, it may have a value based on Table 25.

TABLE 24

| | PUSCH preparation time N₂ |
|---|---|
| μ | [symbols] |
| 0 | 10 |
| 1 | 12 |
| 2 | 23 |
| 3 | 36 |

TABLE 25

| | PUSCH preparation time N₂ |
|---|---|
| μ | [symbols] |
| 0 | 5 |
| 1 | 5.5 |
| 2 | 11 for frequency range 1 |

d_{2,1}: This may indicate the number of symbols which is determined to be 0 when resource elements of the first OFDM symbol are all configured to consist of DMRSs, or 1 otherwise.
κ: 64
μ: This follows a value of μ_{DL} or μ_{UL} which makes T_{proc,2} larger. μ_{DL} refers to numerology of a DL in which a PDCCH including DCI that schedules the PUSCH is transmitted, and μ_{UL} refers to numerology of a UL in which the PUSCH is transmitted.
T_{c}: This may have a value of 1/I(Δfₘₐₓ·N_{f}), Δfₘₐₓ=480·10³ Hz, N_{f}=4096.
d_{2,2}: This may follow a BWP switching time when the DCI that schedules the PUSCH indicates BWP switching, or may be ‘0’ otherwise.

In consideration of time-domain resource mapping information of the PUSCH scheduled by the DCI and an impact of timing advance between the UL and the DL, the BS and the UE may determine that the PUSCH preparation procedure time is not sufficient when a first symbol of the PUSCH starts before a first UL symbol on which CP starts after T_{proc,2} from a last symbol of the PDCCH including the DCI that schedules the PUSCH. Otherwise, the BS and the UE may determine that the PUSCH preparation procedure time is sufficient. Only when the PUSCH preparation procedure time is sufficient, the UE may transmit the PUSCH, and when the PUSCH preparation procedure time is not sufficient, the UE may ignore the DCI that schedules the PUSCH.

Next, PUSCH repetition transmission will now be described. When the UE is scheduled for PUSCH transmission, by DCI format 0_1 in a PDCCH including a CRC scrambled by C-RNTI, MCS-C-RNTI or CS-RNTI, if the UE is configured with pusch-AgreggationFactor as higher layer parameter, same symbol aggregation is applied to slots being consecutive by pusch-AgreggationFactor, and the PUSCH transmission is limited to single rank transmission. For example, the UE has to repeat a same transport block (TB) in slots being consecutive by pusch-AgreggationFactor and has to apply same symbol allocation for each of the slots. Table 26 shows a redundancy version to be applied to PUSCH repetition transmission for each slot. If the UE is scheduled for PUSCH repetition transmission in a plurality of slots by DCI format 0_1, and at least one symbol among the slots in which PUSCH repetition transmission is performed is indicated as a DL symbol according to information of tdd-UL-DL-ConfigurationCommon or tdd-UL-DL-ConfigurationDedicated as higher layer parameter, the UE does not perform PUSCH transmission in a slot in which the corresponding symbol is positioned.

TABLE 26

| rv_{id} indicated by | | | | |
|---|---|---|---|---|
| the DCI | | | | |
| scheduling the | rv_{id} to be applied to n^{th} transmission occasion | | | |
| PUSCH | n mod 4 = 0 | n mod 4 = 1 | n mod 4 = 2 | n mod 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

Also, for PUSCH repetitive transmission, the NR release 16 may define additional methods below for UL-grant based PUSCH transmission and configured-grant based PUSCH transmission that over a slot boundary.
Method 1 (mini-slot level repetition): two or more PUSCH repetitive transmissions in one slot or over boundaries of consecutive slots are scheduled by one UL grant. For Method 1, time domain resource allocation information in DCI indicates a resource for the first repetitive transmission. Also, time domain resource information of the remaining repetitive transmissions may be determined according to the time domain resource information of the first repetitive transmission and the UL/DL direction determined for each symbol of each slot. Each repetitive transmission occupies consecutive symbols.
Method 2 (multi-segment transmission): two or more PUSCH repetitive transmissions in consecutive slots are scheduled by one UL grant. Here, one transmission is designated for each slot, and each transmission may have a different start point or repetition length. Also, in Method 2, time domain resource allocation information in DCI indicates start points and repetition lengths of all the repetitive transmissions. Also, in a case where repetitive transmissions are performed in one slot according to Method 2, when there are several groups of consecutive UL symbols in the slot, each repetitive transmission is performed per each of the UL symbol groups. When there is only one group of consecutive UL symbols in the slot, one PUSCH repetitive transmission is performed according to the method of NR release 15.
Method 3: two or more PUSCH repetitive transmissions in consecutive slots are scheduled by two or more UL grants. Here, one transmission is designated per each slot, and the n-th UL grant may be received before the PUSCH transmission scheduled by the (n−1)-th UL grant is completed.
Method 4: By one UL grant or one configured grant, one or more PUSCH repetitive transmissions in one slot, or two or more PUSCH repetitive transmissions over boundaries of consecutive slots may be supported. The number of repetitions indicated by the BS to the UE is a nominal value, and an actual number of PUSCH repetitions performed by the UE may be greater than the nominal number of repetitions. Time domain resource allocation information in DCI or configured grant refers to a resource of a first repetitive transmission indicated by the BS. Time domain resource information of the rest of repetitive transmissions may be determined by referring to at least the resource information of the first repetitive transmission and UL/DL direction of symbols. If the time domain resource information of the repetitive transmission indicated by the BS span boundaries of slots or includes a UL/DL transition point, the repetitive transmission may be divided into a plurality of repetitive transmissions. Here, one repetitive transmission may be included in each UL period in one slot.

Maximum transmission power being available for UL transmission by the UE may be limited to a power class, an allocated RB, a maximum power reduction (MPR) according to a modulation order, out of band emission, a maximum permissible exposure (MPE), or the like of the UE. The UE may perform transmission power control for transmission of a UL reference signal, a control signal, and data according to limited maximum transmission power. A UE parameter for transmission power may include at least P₀, α, a pathloss estimation value, a size of an allocated frequency block, or the like. According to some embodiments, PUSCH transmission power at a transmission time i with respect to serving cell c, frequency f, and BWP b may be determined by using Equation 2 below.

P_{PUSCH,b,f,c}(i,j,q_{α},l)=min{P_{CMAX,f,c}(i),P_{O-PUSCH,b,f,c}(j)+10 log₁₀(2^{μ}·M_{RB,b,f,c}^{PUSCH}(i))+α_{b,f,c}(j)·PL_{b,f,c}(q_{d})+Δ_{TF,b,f,c}(i)+f_{b,f,c}(i,l)} [dBm] [Equation 2]

In Equation 2 above, parameters may respectively indicate the followings.

P_{CMAX,f,c}(i): This indicates a maximum transmission output of the UE in serving cell c and frequency f, and the UE may determine it based on a P-max value (a preset value when there is no BS) configured by system information or RRC from the BS, a UE power class embedded in the UE, the number of UL serving cells used by the UE, an MPR, and the like.
P_{O-PUSCH,b,f,c}(j): This indicates a value configured by system information or RRC from the BS so as to guarantee a link quality of a reception UE.
2^{μ}·M_{RB,b,f,c}^{PUSCH}(i): This may indicate a size of a frequency block allocated for UL transmission. Here, 2^{μ} may be a parameter for compensation of different power spectral densities (PSDs) according to subcarrier spacings. For example, when subcarrier spacing of 15 kHz is used, μ=0. Even when the same number of frequency blocks are used, if subcarrier spacing is increased twice, e.g., 30 kHz, a spectral density may be reduced in half, compared to a case where subcarrier spacing of 15 kHz is used. Therefore, there is a need to double power to compensate for the reduction. In more detail, in a case where two frequency blocks are used, 10 log 10(2×2⁰)=3 dB is required for subcarrier spacing of 15 kHz, but, it is required to increase reception power to 10 log 10(2×2¹)=6 dB for subcarrier spacing of 30 kHz so as to maintain a same spectral density as subcarrier spacing of 15 kHz.
α: This has a value between 0 and 1 as a parameter for compensation of a pathloss value and may indicate a value configured by system information or RRC from the BS. For example, when α=1, 100% of a pathloss may be compensated for, and when α=0.8, only 80% of a pathloss may be compensated for.
PL_{b,f,c}(q_{d}): This may indicate a pathloss estimation value measured via reference signal q_{d}. Here, a pathloss value may be measured by using Equation 3.

Transmission power of signal being used for pathloss estimation−RSRP measured value of signal being used for pathloss estimation [Equation 3]

Signal q_{d} being used for pathloss estimation in Equation 3 may be one of a CSI-RS transmitted by gNB, a secondary synchronization signal (SSS) transmitted by gNB, or a signal including a DMRS transmitted via a PBCH. In more detail, a gNB may transmit information about transmission power of a reference signal by system information or RRC configuration to a UE1, and the UE1 may measure an RSRP value by using the reference signal transmitted by the gNB. The RSRP value may be L1-RSRP, or L3-RSRP to which a filter indicated by system information/RRC configuration is applied.
Δ_{TF,b,f,c}(i): This indicates a compensation value of transmission power according to a spectral efficiency of a PUSCH channel. That is, when a spectral efficiency is increased (i.e., when a smaller number of resources are used to transmit a same bit or when more bits are transmitted on a same resource), there is a need to use higher transmission power, this parameter is used to compensate for a transmission power value according to the spectral efficiency.
f_{b,f,c}(i,l): This indicates a TPC command for a closed-loop power control. The UE may operate a plurality of closed-loop power controls and thus may be indicated an independent TCP command for each closed-loop, and l indicates an index of a closed-loop.

PUCCH transmission power and SRS transmission power of the UE may be configured in a similar manner to those described above.

In LTE and NR, the UE may perform a procedure for reporting a capability supported by the UE to a serving BS when the UE is connected to the serving BS. In descriptions below, this procedure is called a UE capability report. The BS may transmit, to the UE in a connected state, a UE capability enquiry message requesting to report a UE capability report. The message may include a UE capability request for each radio access technology (RAT) type of the BS. The request for each RAT type may include requested frequency band combination information. Also, in the UE capability enquiry message, the plurality of RAT types may be requested by an RRC message container, or the BS may transmit, to the UE, the UE capability enquiry message including a UE capability request for each RAT type which is repeated multiple times. That is, the UE capability enquiry is repeated multiple times, and the UE may configure a corresponding UE capability information message corresponding thereto and may report it multiple times. In the next-generation mobile communication system, a UE capability request for multi-RAT dual connectivity (MR-DC) as well as NR, LTE, E-UTRA-NR dual connectivity (EN-DC) may be performed. Also, it is common that the UE capability enquiry message is transmitted in an initial stage after the UE is connected, but the UE capability enquiry message may be requested in any condition when the BS needs.

When the UE receives a request to report the UE capability from the BS, the UE configures a UE capability according to an RAT type and band information requested from the BS. A method by which the UE configures a UE capability in the NR system is summarized below.

1. If the UE is provided an LTE and/or NR band list in a request for UE capability from the BS, the UE may configure a band combination (BC) for EN-DC and NR stand-alone (SA). That is, the UE configures a candidate BC list for the EN-DC and NR SA, based on bands requested to the BS in FreqBandList. Also, priorities of the bands may have priorities in order of being listed in FreqBandList.

2. If the BS requests a UE capability report by setting a flag “eutra-nr-only” or “eutra”, the UE completely removes information about NR SA BCs from the configured candidate BC list. This operation may occur only when an LTE BS (eNB) requests a “eutra” capability.

3. Afterward, the UE removes fallback BCs from the configured candidate BC list. Here, the fallback BC refers to a BC that is obtainable by removing a band corresponding to at least one SCell from a random super set BC, and may be omitted because the super set BC may already cover the fallback BC. This operation is also applied in MR-DC, i.e., even to LTE bands. BCs that remain after this operation are a final “candidate BC list”.

4. The UE selects BCs to be reported, by selecting BCs being appropriate for a requested RAT type from the final “candidate BC list”. In this operation, the UE configures supportedBandCombinationList in a defined order. That is, the UE may configure BCs and UE capability to be reported, in order of preset RAT-types. (nr->eutra-nr->eutra). Also, the UE may configure featureSetCombination for the configured supportedBandCombinationList, and may configure a “candidate feature set combination” list from the candidate BC list from which a list of the fallback BCs (including equal or low-level capability) is removed. The “candidate feature set combinations” include all feature set combinations for NR and EUTRA-NR BCs, and may be obtained from feature set combinations of UE-NR-Capabilities and UE-MRDC-Capabilities containers.

5. Also, if the requested RAT type is eutra-nr and has an impact on the list, featureSetCombinations are all included in both two containers that are the UE-MRDC-Capabilities and UE-NR-Capabilities. However, a feature set of NR is included only in UE-NR-Capabilities.

After the UE capability is configured, the UE transmits, to the BS, a UE capability information message including the UE capability. The BS performs scheduling and transmission/reception management appropriate for the UE, based on the UE capability received from the UE.

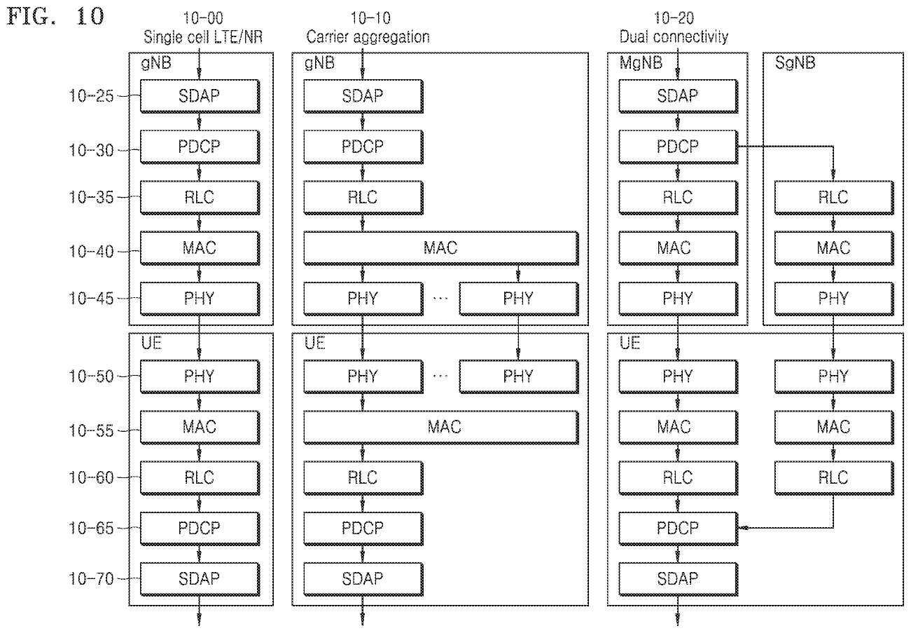

FIG. 10 is a diagram illustrating radio protocol architecture of a BS and a UE in performing of a single cell, carrier aggregation and dual connectivity according to some embodiments of the disclosure.

Referring to FIG. 10, a radio protocol of a next-generation wireless communication system may include, in each of the UE and the NR BS, an NR service data adaptation protocol (NR SDAP) layer 10-25 or 10-70, an NR packet data convergence protocol (NR PDCP) layer 10-30 or 10-65, an NR radio link control (NR RLC) layer 10-35 or 10-60, and an NR medium access control (NR MAC) layer 10-40 or 10-55.

Main functions of the NR SDAP layer 10-25 or 10-70 may include some of the following functions.
Transfer of user plane data
Mapping between a quality of service (QoS) flow and a data radio bearer (DRB) for both DL and UL
Marking QoS flow ID in both DL and UL packets
Reflective QoS flow to DRB mapping for the UL SDAP protocol data units (PDUs).

With respect to a SDAP layer entity, information about whether to use a header of the SDAP layer entity or to use functions of the SDAP layer entity may be configured for the UE by using a RRC message per PDCP layer entity, per bearer, or per logical channel, and when the SDAP header is configured, the UE may direct to update or reconfigure UL and DL QoS flow and data bearer mapping information by using a 1-bit non access stratum (NAS) reflective QoS indicator and a 1-bit access stratum (AS) reflective QoS indicator of the SDAP header. The SDAP header may include QoS flow ID information indicating QoS. QoS information may be used as data processing priority information or scheduling information for seamlessly supporting a service.

Main functions of the NR PDCP layer 10-30 or 10-65 may include some of the following functions.
Header compression and decompression: ROHC only
Transfer of user data
In-sequence delivery of upper layer PDUs
Out-of-sequence delivery of upper layer PDUs
PDCP PDU reordering for reception
Duplicate detection of lower layer service data units (SDUs)
Retransmission of PDCP SDUs
Ciphering and deciphering
Timer-based SDU discard in uplink.

In the above descriptions, the reordering function of the NR PDCP entity may indicate a function of reordering PDCP PDUs received from a lower layer, on a PDCP sequence number (SN) basis, and may include a function of delivering the reordered data to an upper layer in order, or may include a function of delivering the reordered data to an upper layer out of order, a function of recording missing PDCP PDUs by reordering the received PDCP PDUs, a function of reporting status information of the missing PDCP PDUs to a transmitter, and a function of requesting to retransmit the missing PDCP PDUs.

Main functions of the NR RLC layer 10-35 or 10-60 may include some of the following functions.
Transfer of upper layer PDUs
In-sequence delivery of upper layer PDUs
Out-of-sequence delivery of upper layer PDUs
Error correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

In the above descriptions, the in-sequence delivery function of the NR RLC entity indicates a function of delivering RLC SDUs received from a lower layer to an upper layer in order, when a plurality of RLC SDUs segmented from one RLC SDU are received, the in-sequence delivery function of the NR RLC entity may include a function of reassembling the RLC SDUs and delivering the reassembled RLC SDU, a function of reordering received RLC PDUs on a RLC SN or PDCP SN basis, a function of recording missing RLC PDUs by reordering the received RLC PDUs, a function of reporting status information of the missing RLC PDUs to a transmitter, and a function of requesting to retransmit the missing RLC PDUs, and the in-sequence delivery function of the NR RLC entity may include a function of delivering only RLC SDUs prior to a missing RLC SDU, to an upper layer in order when the missing RLC SDU exists, or a function of delivering all RLC SDUs received before a timer starts, to an upper layer in order although a missing RLC SDU exists when a certain timer expires, or the in-sequence delivery function of the NR RLC entity may include a function of delivering all RLC SDUs received so far, to an upper layer in order although a missing RLC SDU exists when a certain timer expires. The NR RLC entity may process the RLC PDUs in order of reception and deliver the RLC PDUs to the NR PDCP entity (regardless of SNs (out-of-sequence delivery)), and when a segment is received, the NR RLC entity may reassemble the segment with other segments stored in a buffer or to be subsequently received, into a whole RLC PDU and may process and deliver the RLC PDU to the NR PDCP entity. The NR RLC layer may not have a concatenation function, and the concatenation function may be performed by the NR MAC layer or be substituted with a multiplexing function of the NR MAC layer.

In the descriptions above, the out-of-sequence delivery function of the NR RLC entity may include a function of directly delivering RLC SDUs received from a lower layer to an upper layer out of order, a function of reassembling a plurality of RLC SDUs segmented from one RLC SDU and delivering the reassembled RLC SDU when the segmented RLC SDUs are received, and a function of recording missing RLC PDUs by storing RLC SNs or PDCP SNs of received RLC PDUs and reordering the received RLC PDUs.

The NR MAC layer 10-40 or 10-55 may be connected to a plurality of NR RLC layer entities configured for one UE, and main functions of the NR MAC layer S40 or S55 may include some of the following functions.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

An NR PHY layer 10-45 or 10-50 may channel-code and modulate upper layer data into OFDM symbols and may transmit the OFDM symbols through a wireless channel, or may demodulate OFDM symbols received through a wireless channel and channel-decode and may deliver the OFDM symbols to an upper layer.

The radio protocol architecture may be variously changed according to carrier (or cell) operation schemes. For example, when the BS transmits data to the UE on a single carrier (or cell), the BS and the UE use protocol architecture having a single structure for each layer, as shown in 10-00. On the other hand, when the BS transmits data to the UE based on a CA in which a single transmission and reception point (TRP) uses multiple carriers, the BS and the UE use protocol architecture having a single structure up to the RLC layer, in which the PHY layer is multiplexed via the MAC layer, as shown in 10-10. In another example, when the BS transmits data to the UE based on a dual connectivity (DC) in which multiple TRPs use multiple carriers, the BS and the UE use protocol architecture having a single structure up to the RLC layer, in which the PHY layer is multiplexed via the MAC layer, as shown in 10-20.

Referring to descriptions related to the DCI structure, PUSCH time/domain resource allocation and PUSCH transmission and reception procedure performed based on them, the NR system according to the NR release 15 uses only single transmission point/panel/beam in PUSCH repetition transmission. If cooperative communication using a plurality of transmission points/panels/beams is applicable to the PUSCH repetition transmission, a more robust performance to channel blockage may be achieved, and thus, for the NR release 17, a repetition transmission technique using a plurality of transmission points/panels/beams may be actively discussed.

For each PUSCH repetition transmission, a channel between the UE and each transmission point/panel/beam may experience different pathloss and blockage, and due to a limited power of the UE, it may be difficult to equally match transmission powers, modulation and coding schemes (MCSs), or the number of RBs allocated for PUSCH repetition transmissions. Here, a TB size and a low-density parity-check base graph (LDPC BG) of a PUSCH may be calculated from an MCS and an amount of resources allocated to the PUSCH according to the Rel. 15 NR, and therefore, a TB size per PUSCH repetition transmission and an LDPC BG are different from each other, such that i) it is unclear which value among a plurality of TB sizes and LDPC BGs which are different is correct, ii) combining between repetition transmission PUSCHs is unavailable. The disclosure provides a method for solving the aforementioned problems by equalizing a TB size and an LDPC BG for each repetition transmission.

Hereinafter, in the disclosure, when the UE determines whether to apply the cooperative communication, the UE may use various methods in which PDCCH(s) that allocates a PUSCH, to which the cooperative communication is applied, has a particular format, PDCCH(s) that allocates a PUSCH, to which the cooperative communication is applied, includes a particular indicator to indicate whether the cooperative communication is applied, PDCCH(s) that allocates a PUSCH, to which the cooperative communication is applied, is scrambled by a particular RNTI, or application of the cooperative communication is assumed in a particular section indicated by an upper layer parameter. For convenience of descriptions, a case in which the UE receives the PUSCH to which the cooperative communication is applied based on conditions similar to those as described above will now be referred to as a non-coherent joint transmission (NC-JT) case.

Hereinafter, in the disclosure, determining priorities between A and B may refer to selecting one of A and B which has a higher priority according to a preset priority rule and performing an operation corresponding thereto or omitting or dropping an operation for the other one having a lower priority.

Hereinafter, in the disclosure, the above examples will now be described in several embodiments, but the examples are not independent and one or more embodiments may be applied simultaneously or in combination.

### First Embodiment: DCI Reception for DL NC-JT

Unlike the legacy communication system, the 5G wireless communication system may support not only services requiring high data rate but may also support both services having very short latency and services requiring a high connection density. In a wireless communication network including multiple cells, TRPs, or beams, cooperative communication between the respective cells, TRPs and/or beams may satisfy various service requirements by increasing strength of a signal received by the UE or efficiently performing control on interference between the respective cells, TRPs and/or beams.

JT is a representative transmission technology for the cooperative communication, and is a technology for increasing strength of a signal, which received by the UE, by supporting one UE via many different cells, TRPs or/and beams. Here, properties of respective channels between the cells, TRPs and/or beams and the UE may significantly differ, and thus, there is a need to apply different precodings, MCSs, resource allocations, and the like to links between respective cells, TRPs, and/or beams and the UE. In particular, for NC-JT that supports non-coherent precoding between the cells, the TRPs and/or the beams, individual DL transmission information configuration for each cell, each TRP, and/or each beam is important. However, such individual DL transmission information configuration for each cell, each TRP, and/or each beam may be a main cause of an increase in payload required for transmission of the DL DCI, and may have a negative impact on reception performance for a PDCCH that transmits the DCI. Therefore, in order to support JT, it is required to carefully design a tradeoff between an amount of DCI information and PDCCH reception performance.

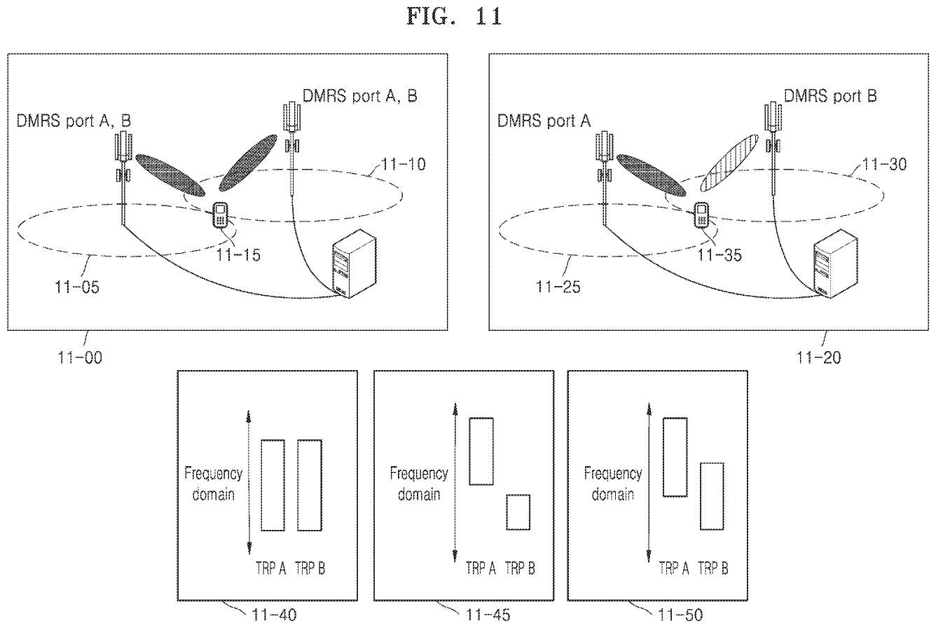

FIG. 11 is a diagram illustrating antenna port configuration and resource allocation for cooperative communication in a wireless communication system according to an embodiment of the disclosure.

Referring to FIG. 11, an example of JT scheme and examples for allocating radio resources for each TRP are illustrated. Referring to FIG. 11, an example 11-00 is an example of coherent joint transmission (C-JT) that supports coherent precoding between respective cells, TRPs and/or beams. For C-JT, TRP A 11-05 and TRP B 11-10 transmit single data (PDSCH) to a UE 11-15, and joint precoding may be performed in the multiple TRPs. This may mean that same DMRS ports (e.g., DMRS ports A and B from both TRPs) are transmitted from TRP A 11-05 and TRP B 11-10 to transmit a same PDSCH. In this case, the UE may receive one DCI information so as to receive one PDSCH demodulated based on the DMRS transmitted via the DMRS ports A and B.

Referring to FIG. 11, an example 11-20 of NC-JT that supports non-coherent precoding between the respective cells, TRPs and/or beams for PDSCH transmission is shown. In a case of NC-JT, a PDSCH may be transmitted to the UE 11-35 for each cell, TRP N025 or N030 and/or beam, and individual precoding may be applied to each PDSCH. Each cell, TRP and/or beam transmits a different PDSCH, such that throughput may be improved compared to singe cell, TRP and/or beam transmission. Also, each cell, TRP and/or beam repetitively transmits the same PDSCH to the UE, such that reliability may be improved compared to singe cell, TRP and/or beam transmission.

In this case, various radio resource allocations such as a case where frequency and time resources used for PDSCH transmission at the multiple TRPs are the same in 11-40, a case where frequency and time resources used for PDSCH transmission at the multiple TRPs do not overlap each other in 11-45, and a case where some of frequency and time resources used at the multiple TRPs overlap each other in 11-50 may be considered. In each case above for radio resource allocation, when a plurality of TRPs repeatedly transmit a same PDSCH for improvement of reliability, if a reception UE does not know that the PDSCH is being repeatedly transmitted, the corresponding UE cannot perform combining for the PDSCH in a physical layer, and thus, there may be a limit in improvement of reliability. Therefore, the disclosure provides a repetition transmission indication and configuration method for improving reliability of NC-JT transmission.

In order to simultaneously allocate a plurality of PDSCHs to one UE so as to support NC-JT, various forms, structures and relations of DCI may be considered.

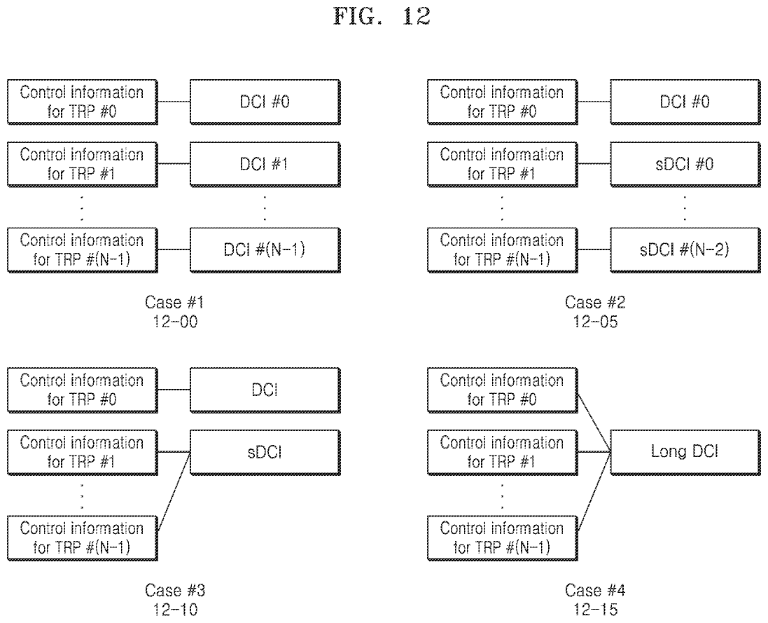

FIG. 12 is a diagram illustrating an example of configuration of DCI for cooperative communication in a wireless communication system according to an embodiment of the disclosure.

Referring to FIG. 12, four examples of a design of DCI for supporting NC-JT.

Referring to FIG. 12, case #1 12-00 shows a case where N−1 different PDSCHs are transmitted from additional N−1 TRPs (TRP #1 to TRP #(N−1)) in addition to a serving TRP (TRP #0) used in single PDSCH transmission, in which control information for the PDSCHs transmitted from the additional N−1 TRPs is transmitted in a same DCI format as control information for the PDSCH transmitted from the serving TRP. That is, the UE may obtain the control information for the PDSCHs transmitted from different TRPs (TRP #0 to TRP #(N−1)) by a plurality of pieces of DCI (DCI #0 to DCI #(N−1)) all having the same DCI format and same payload.

In case #1 described above, degrees of freedom of each PDSCH control (allocation) may be fully ensured, but when each DCI is transmitted from different TRPs, the reception performance may deteriorate as a coverage difference between the plurality of pieces of separate DCI may occur.

Case #2 12-05 shows a case where N−1 different PDSCHs are transmitted from additional N−1 TRPs (TRP #1 to TRP #(N−1) in addition to a serving TRP (TRP #0) used in single PDSCH transmission, in which control information for the PDSCHs transmitted from the additional N−1 TRPs is transmitted in a different DCI format or different DCI payload from the control information for the PDSCH transmitted from the serving TRP. For example, DCI #0 that is control information for the PDSCH transmitted from the serving TRP (TRP #0) includes all information elements of DCI format 1_0 or DCI format 1_1, but shortened DCI (hereinafter sDCI) (sDCI #0 to sDCI #(N−2)) that is control information for the PDSCHs transmitted from the cooperative TRPs (TRP #1 to TRP #(N−1)) may include only some of the information elements of DCI format 1_0 or DCI format 1_1. Therefore, the sDCI for transmission of the control information for the PDSCHs transmitted from the cooperative TRPs may have a small payload compared to normal DCI (nDCI) for transmission of control information associated with the PDSCH transmitted from the serving TRP, or may include reserved bits corresponding to lacking bits, compared to the nDCI.

In case #2 described above, the degree of freedom of each PDSCH control (allocation) may be limited depending on content of the information element included in the sDCI, but, as reception performance for the sDCI is superior to that of the nDCI, a probability of coverage difference for each DCI may be reduced.

Case #3 12-10 shows a case where N−1 different PDSCHs are transmitted from additional N−1 TRPs (TRP #1 to TRP #(N−1)) in addition to a serving TRP (TRP #0) used in single PDSCH transmission, in which control information for the PDSCHs transmitted from the additional N−1 TRPs is transmitted in a different DCI format or different DCI payload from the control information for the PDSCH transmitted from the serving TRP. For example, DCI #0 that is control information for the PDSCH transmitted from the serving TRP (TRP #0) may include all information elements of DCI format 1_0 or DCI format 1_1, and control information for the PDSCHs transmitted from the cooperative TRPs (TRP #1 to TRP #(N−1)) may collect and transmit only some of the information elements of DCI format 1_0 or DCI format 1_1 into ‘secondary’ DCI (sDCI). For example, the sDCI may include at least one of HARQ-related information such as frequency domain resource allocation, time domain resource allocation, an MCS or the like, for the cooperative TRPs. In addition, for information that is not included in the sDCI, such as a BWP indicator or a carrier indicator, the UE may follow the DCI (DCI #0, normal DCI, and nDCI) of the serving TRP.

Case #3 may have a limited degree of freedom of each PDSCH control (allocation) according to content of an information element included in sDCI, but may control sDCI reception performance and have reduced complexity of DCI blind decoding of the UE compared to case #1 or case #2.

Case #4 12-15 shows a case where N−1 different PDSCHs are transmitted from additional N−1 TRPs (TRP #1 to TRP #(N−1)) in addition to a serving TRP, TRP #0 used for single PDSCH transmission, in which control information for the PDSCHs transmitted from the additional N−1 TRPs is transmitted in the same DCI (long DCI (IDCI)) as the control information for the PDSCH transmitted from the serving TRP. That is, the UE may obtain the control information for the PDSCHs transmitted from the different TRPs (TRP #0 to TRP #(N−1)) by single DCI. In case #4, DCI blind decoding complexity of the UE may not increase, but a degree of freedom of PDSCH control (allocation) may be decreased such as the number of cooperative TRPs being limited due to limitations on the long DCI payload.

In the descriptions and embodiments below, sDCI may refer to various auxiliary DCI such as shortened DCI, secondary DCI, or normal DCI (with DCI formats 1_0 to 1_1 described above) including control information of a PDSCH transmitted from a cooperative TRP, and the descriptions thereof may be similarly applied to the various auxiliary DCI unless otherwise specified.

In the descriptions and embodiments below, case #1, case #2, and case #3 described above in which one or more pieces of DCI (PDCCHs) are used to support NC-JT may be classified as multiple-PDCCH-based NC-JT, and case #4 in which single DCI (a PDCCH) is used to support NC-JT may be classified as single-PDCCH-based NC-JT.

In embodiments of the disclosure, the term “cooperative TRP” may be substituted with various terms including a “cooperative panel” or a “cooperative beam” when actually implemented or applied.

In embodiments of the disclosure, the expression that “NC-JT is applied” may be variously interpreted based on the context such as “the UE simultaneously receives one or more PDSCHs on one BWP”, “the UE simultaneously receives PDSCHs on one BWP based on two or more TCI indication”, “a PDSCH received by the UE is associated with one or more DMRS port group”, or the like. However, in the disclosure, for convenience of descriptions, an embodiment may be described using one expression.

In the disclosure, radio protocol architecture for NC-JT may be variously used according to TRP usage scenarios. For example, when there is no or small backhaul delay between cooperative TRPs, a structure based on MAC layer multiplexing similar to what is shown in 10-10 of FIG. 10 may be used (CA-like method). On the other hand, when there is a backhaul delay between cooperative TRPs, the delay being significantly large that cannot be ignored (e.g., when 2 ms or more time is required to exchange information such as CSI, scheduling, HARQ-ACK, or the like between the cooperative TRPs), an independent structure for each TRP from the RLC layer which is similar to 10-20 of FIG. 10 may be used to secure robustness to delay (DC-like method).

### First-1 Embodiment: Method of Configuring DL Control Channel for Multi-PDCCH Based NC-JT Transmission

In transmission of DCI for PDSCH scheduling of each TRP, The multi-PDCCH based NC-JT may have a CORESET or a search space distinguished for each TRP. The CORESET or search space for each TRP may be configured as at least one of cases below.
Higher layer index configuration for each CORESET: a TRP that transmits the PDCCH in the configured CORESET may be identified by the index value for the configured CORESET. That is, the UE may assume that, in a set of CORESETs having a same higher layer index value, a same TRP transmits a PDCCH or a PDCCH scheduling a PDSCH of the same TRP is transmitted. The index for each CORESET may be called CORESETPoolIndex.
Multiple PDCCH-Config configuration: Multiple PDCCH-Configs are configured in one BWP, and each PDCCH-Config may include PDCCH configuration for each TRP. PDCCH configuration for each TRP may be configured with a CORESET list for each TRP and/or a search space list for each TRP.
CORESET beam/beam group configuration: a TRP corresponding to a CORESET may be identified based on a beam or beam group configured for each CORESET. For example, when a same TCI state is configured for a plurality of CORESETs, the UE may assume that the CORESETs are transmitted at the same TRP or a PDCCH scheduling a PDSCH of the same TRP is transmitted in the CORESET.
Search space beam/beam group configuration: a beam or beam group is configured for each search space, and by doing so, a TRP for each search space may be identified. For example, when a same beam/beam group or TCI state is configured for a plurality of search spaces, the UE may assume that the same TRP transmits a PDCCH in the search space or a PDCCH scheduling a PDSCH of the same TRP is transmitted in the search space.

By identifying the CORESET or search space for each TRP, classification of PDSCH and HARQ-ACK information for each TRP may be possible, such that it is possible to generate separate HARQ-ACK codebook and to use separate PUCCH resource for each TRP.

### First-2 Embodiment: PDSCH Repetition for Multi-TRP

In the present embodiment, provided are detailed configuration and an indication method by which at least two TRPs can repeatedly transmit a same PDSCH in a same transmission band (e.g., a transmission band, a component carrier, a BWP, and the like).

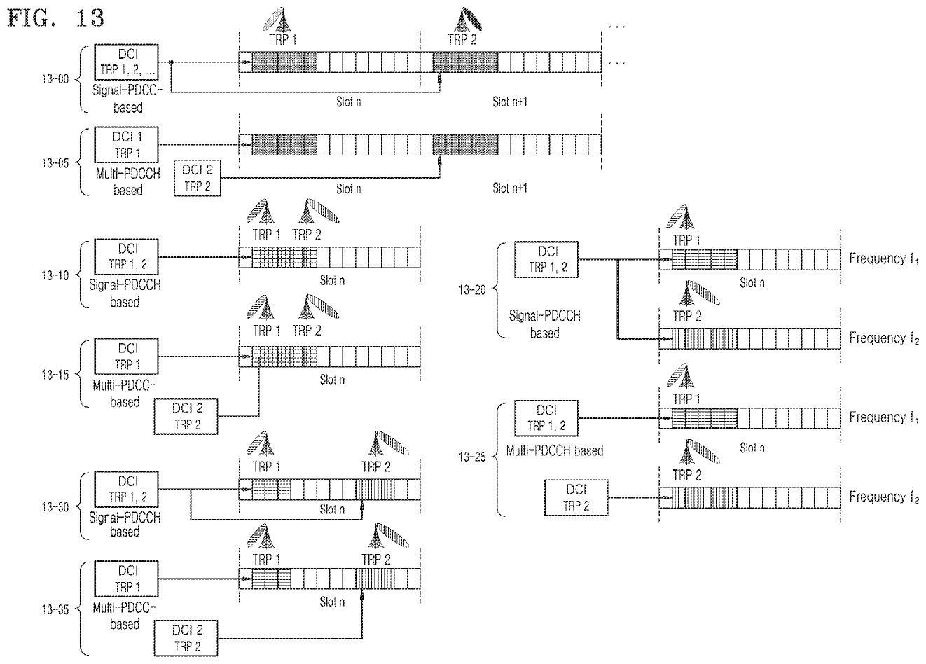

FIG. 13 is a diagram illustrating an example of repetition transmission by multiple TRPs to which various resource allocation methods are applied in a wireless communication system according to an embodiment of the disclosure. Referring to FIG. 13, provided is an example in which at least two TRPs repeatedly transmit a same PDSCH.

In the current NR, when the same PDSCH is repeatedly transmitted as described above, slots corresponding to the number of repetition transmissions may be required, and a same cell, TRP and/or beam may be used for each repetition transmission. On the other hand, according to an embodiment of the disclosure, different TRPs are used at each repetition transmission in each slot, such that higher reliability may be achieved (13-00 and 13-05). According to capability and latency requirement of a UE, available resource states of TRPs, and the like, different repetition transmission methods may be used. For example, when the UE has capability to receive NC-JT, each TRP may use a method of transmitting a same PDSCH on a same time and frequency resource, thereby increasing a frequency resource usage rate and decreasing latency required for PDSCH decoding (13-10 and 13-15). The method may be efficient when interference between beams is small as beams between TRPs for simultaneous transmission are nearly orthogonal to each other. As another example, each TRP may use a method of transmitting a same PDSCH on same time and not-overlapping frequency resources (13-20 and 13-25). The method may be efficient when interference between beams of TRPs for simultaneous transmission is large, and each TRP has many available frequency resources. As another example, each TRP may use a method of transmitting a same PDSCH on different OFDM symbols in a same slot (13-30 and 13-35). The method may be efficient when each TRP does not have many available frequency resources and a size of data to be transmitted is small. In addition to the above methods, modifications based on the above methods may be available.

In order to schedule repetition transmission in the above methods, single DCI may be used (13-00, 13-10, 13-20, and 13-30), and the DCI may indicate a list of all TRPs to participate in repetition transmission. The list of TRPs to perform repetition transmission may be indicated in the form of a TCI state list, and a length of the TCI state list may be dynamically changed. The DCI may be repeatedly transmitted to improve reliability, and a different beam may be applied for each DCI in repetition transmission. Alternatively, in order to schedule repetition transmission, multiple DCIs may be used (13-05, 13-15, 13-25, and 13-35), and DCIs may respectively correspond to PDSCHs of different TRPs to participate in repetition transmission. A TRP for each DCI may be indicated by a TCI state or a resource to be used in repetition transmission, and detailed descriptions thereof will be provided in embodiments below. Alternatively, in order to schedule repetition transmission, shortened DCI may be used. Also, in order to schedule repetition transmission, secondary DCI may be used. Normal DCI and each of shortened DCU/secondary DCI may respectively correspond to PDSCHs of different TRPs to participate in repetition transmission. The aforedescribed indication methods may be commonly applied to both repetition transmission via multiple TRPs and transmission of different data via multiple TRPs.

### Second Embodiment: PUSCH Repetition for Multi-TRP

In the present embodiment, provided are detailed configuration and an indication method by which a UE can repeatedly transmit a same PUSCH to multiple TRPs so as to improve transmission reliability of the PUSCH.

When the PUSCH is repeatedly transmitted to multiple TRPs, a method by which overlapping time-frequency resources are allocated to the PUSCH being transmitted to each TRP and a spatial resource is differently allocated may be used. Also, a method by which overlapping time resources are allocated to a PUSCH being transmitted to each TRP and not-overlapping frequency resources are allocated may be used. Also, a method by which overlapping frequency resources are allocated to a PUSCH being transmitted to each TRP and not-overlapping time resources are allocated may be used. Here, respective PUSCHs may be allocated to different slots or may be allocated to different symbols in a same slot. Also, a method by which not-overlapping frequency and time resources are allocated to a PUSCH being transmitted to each TRP may be used. In addition to the above methods, modifications based on the above methods may be available.

Which method among the PUSCH repetition transmission methods described above is to be used may be semi-statically indicated to the UE by an upper layer via RRC (e.g., higher layer signaling or RRC signaling) or may be dynamically indicated to the UE by an MAC CE or UL DCI. When PUSCH repetition transmission is indicated by UL DCI, one UL DCI may be used or multiple UL DCIs may be used. When one UL DCI is used, the one DCI may schedule all PUSCH repetition transmissions, and may include all of time and/or frequency allocation information about all PUSCH repetition transmissions and beam/precoding information for each TRP to which each PUSCH is to be transmitted. When multiple UL DCIs are used, the UL DCIs may respectively schedule PUSCH repetition transmissions, and each DCI may include time and/or frequency allocation information about each PUSCH repetition transmission and beam/precoding information for each PUSCH. Here, each UL DCI may explicitly/implicitly include an indicator to indicate repetition transmission of a same PUSCH. Also, some UL DCIs among the multiple UL DCIs may be shortened DCIs.

If independent codeword is transmitted for each of the PUSCH repetition transmissions, the UE may perform a procedure below per codeword for codeword decoding.

1) TB size calculation based on the number of REs, an MCS, and the like corresponding to a resource on which codeword is transmitted

2) Determination of an LDPC BG from a TB size and a target code rate

Parameters used in the procedure above may indicate the followings.
N_RE: A total number of REs allocated to PUSCH scheduling The total number of REs allocated to PUSCH scheduling may be calculated based on the frequency-domain RB resource allocation information and the time-domain symbol resource allocation information.
R: A target code rate indicated by an MCS
Q_m: A modulation order indicated by an MCS
v: The number of layers indicated in a precoding information and number of layers field or an SRI field.

Transmission power per PUSCH repetition transmission to multiple TRPs within given maximum transmission power of the UE may be changed due to pathloss between the UE and TRPs, and as described above, when pathloss is increased, PUSCH transmission power of the UE may be increased to compensate for the pathloss. However, if pathloss between the UE and a particular TRP is very large, compensation of the pathloss within an allocated number of RBs and maximum transmission power condition may be unavailable, and it may be requested to decrease the number of RBs for compensation of the pathloss. Therefore, if pathloss of each of channels between the UE and TRPs varies in PUSCH repetition transmissions to multiple TRPs, the number of RBs allocated to each repetition transmission may have to vary. Also, as a state of each of channels between the UE and TRPs varies, an MCS indicated for each repetition transmission may vary. Accordingly, a TB size and an LDPC BG being calculated per each repetition transmission may vary, and the UE may not identify which TB size and LDPC BG the UE has to refer to encode and transmit a repetition transmission PUSCH. Therefore, there is a need to equally match TB sizes and LDPC BGs for all repetition transmission PUSCHs, and for the need, methods below may be considered.

Method 1) Configuration of a representative value for calculation of TB sizes and LDPC BGs of the UE and the BS in repetition transmissions

Method 2) The BS performs scheduling to allow TB sizes and LDPC BGs for all repetition transmission PUSCHs to be equal.

### Second-1 Embodiment: Configuration of a Representative Value of Each of TB Sizes and LDPC BGs for Repetition Transmission PUSCHs

In order to repeatedly transmit a PUSCH to each TRP, the UE may be indicated explicit or implicit information indicating to which TRP each repetition transmission PUSCH is to be transmitted. The explicit or implicit information about TRP may be one or a combination of a plurality of pieces of information being listed below.
1) Transmission power value or its associated parameter
2) Transmission beam/precoder
3) Scheduling information

The detailed descriptions of the information above are provided below.
1) Transmission Power Value or Associated Parameter

The BS may differently configure transmission power values for respective PUSCH repetition transmissions so as to perform PUSCH repetition transmission for each TRP. To do so, for example, when a PUSCH transmission power value follows Equation 2 above, the BS may differently configure a parameter below or a combination thereof for each PUSCH repetition transmission.

Parameter j: In PUSCH repetition transmission for each TRP, A P_{O-PUSCH,b,f,c}(j) and/or α_{b,f,c}(j) which are PUSCH transmission power parameters for each repetition transmission may be differently configured. For example, when an SRI is indicated in PUSCH repetition transmission scheduling, the PUSCH transmission power parameter P_{O-PUSCH,b,f,c}(j) and/or α_{b,f,c}(j) may be mapped to a value of the SRI. Therefore, by applying different SRIs to respective PUSCH transmissions being transmitted to different TRPs, the transmission power parameter may be changed for each TRP. Alternatively, a mapping relation between an upper layer index CORESETPoolIndex configured for each CORESET and the PUSCH transmission power parameter P_{O-PUSCH,b,f,c}(j) and/or α_{b,f,c}(j) is defined, such that, when PUSCH repetition transmissions are scheduled by multiple UL DCIs and each UL DCI is connected to different CORESETPoolIndexes, the transmission power parameter may be changed for each TRP. Alternatively, according to a combination of an SRI and CORESETPoolIndex, the transmission power parameter may be changed for each TRP.
Pathloss measurement RS q_{d}: In PUSCH repetition transmission for each TRP, pathloss measurement RS may be differently configured for each repetition transmission. For example, when an SRI is indicated in PUSCH repetition transmission scheduling, a value of the SRI and pathloss measurement RS q_{d} may be mapped. Therefore, by applying different SRIs to respective PUSCH transmissions being transmitted to different TRPs, the pathloss measurement RS may be changed for each TRP. Alternatively, a mapping relation between an upper layer index CORESETPoolIndex configured for each CORESET and the pathloss measurement RS q_{d} is defined, such that, when PUSCH repetition transmissions are scheduled by multiple UL DCIs and each UL DCI is connected to different CORESETPoolIndexes, the pathloss measurement RS may be changed for each TRP. Alternatively, according to a combination of an SRI and CORESETPoolIndex, the pathloss measurement RS may be changed for each TRP. Here, the BS may be configured to be reported L1-RSRP or L3-RSRP with respect to the pathloss measurement RS q_{d} for PUSCH transmission for each TRP or may be reported L1-RSRP and then may measure L3-RSRP based on the L1-RSRP.
Closed loop index I: In PUSCH repetition transmission scheduling for each TRP, a closed loop for power control for each repetition transmission may be differently applied. For example, when an SRI is indicated in PUSCH repetition transmission scheduling, a value of the SRI and closed loop index I may be mapped to each other.

Therefore, by applying different SRIs to respective PUSCH transmissions being transmitted to different TRPs, the closed loop index may be differently applied for each TRP. Alternatively, a mapping relation between an upper layer index CORESETPoolIndex configured for each CORESET and the closed loop index is defined, such that, when PUSCH repetition transmissions are scheduled by multiple UL DCIs and each UL DCI is connected to different CORESETPoolIndex, the closed loop index may be differently applied for each TRP. Alternatively, according to a combination of an SRI and CORESETPoolIndex, the closed loop index may be differently applied for each TRP.
P_{CMAX,f,c}(i): In PUSCH repetition transmission scheduling for each TRP, maximum transmission power P_{CMAX,f,c}(i) being allocable for each repetition transmission may vary. For example, in a case where maximum power reduction (MPR) being applied to each PUSCH transmission varies as a frequency resource allocated for PUSCH transmission varies for each TRP, MPE may be differently applied to each PUSCH transmission for each TRP.
Power headroom report: When the UE reports a power headroom report for each TRP, each PUSCH repetition transmission may correspond to each target TRP of the power headroom report.

The BS and the UE may select a power transmission parameter for each TRP or a combination of parameters, may calculate a TB size and an LDPC BG corresponding to a PUSCH to be transmitted, based on the selected parameter or the combination of parameters, and may apply the calculated TB size and LDPC BG to all PUSCH repetition transmissions. For example, if the BS can estimate pathloss between each TRP and the UE (e.g., via L1-RSRP report on pathloss measurement RS), the BS may select a PUSCH with largest pathloss, may calculate a TB size and an LDPC BG corresponding thereto, and then may apply the calculated TB size and LDPC BG to all PUSCH repetition transmissions.

2) Transmission Beam/Precoder

In PUSCH repetition transmission, different transmission beams or precoders may be respectively applied to PUSCH transmissions to TRPs. The transmission beam or the precoder may include at least one of the followings.
In a case of codebook based transmission, information indicating an SRS resource existing in an SRS resource set. Here, different SRS resources or SRIs may respectively correspond to PUSCH transmissions to TRPs.
In a case of codebook based transmission, information indicating TPMI Here, different TPMIs may respectively correspond to PUSCH transmissions to TRPs.
In a case of non-codebook based transmission, information indicating an SRI. Here, different SRIs may respectively correspond to PUSCH transmissions to TRPs.
In a case of non-codebook based transmission, information indicating associatedCSI-RS. Here, different associatedCSI-RSs may respectively correspond to PUSCH transmissions to TRPs.
In a case of codebook based or non-codebook based transmission, information indicating a SRS resource set. Here, different SRS resource sets may respectively correspond to PUSCH transmissions to TRPs.
In a case of codebook based or non-codebook based transmission, information indicating a panel. Here, different panel indices may respectively correspond to PUSCH transmissions to TRPs.
In a case of codebook based or non-codebook based transmission, information indicating a (UL) TCI state. Here, different (UL) TCI states may respectively correspond to PUSCH transmissions to TRPs. Alternatively, different (UL) TCI states may respectively correspond to SRS resources corresponding to PUSCH transmissions to TRPs.
In a case of codebook based or non-codebook based transmission, information indicating spatial relation info. Here, different spatial relation infos may respectively correspond to PUSCH transmissions to TRPs. Alternatively, different spatial relation infos may respectively correspond to SRS resources corresponding to PUSCH transmissions to TRPs.

The BS and the UE may select a parameter for each TRP or a combination of parameters, which indicate beam/precoder, may calculate a TB size and an LDPC BG corresponding to a PUSCH to be transmitted, based on the selected parameter or the combination of parameters, and may apply the calculated TB size and LDPC BG to all PUSCH repetition transmissions. For example, the BS and the UE may select a PUSCH corresponding to a particular SRI (e.g., SRI=0) in a case of codebook based transmission, may calculate a TB size and an LDPC BG corresponding to the PUSCH, and may apply the calculated TB size and LDPC BG to all PUSCH repetition transmissions.

3) Scheduling Information

In PUSCH repetition transmission, different scheduling information may be applied to PUSCH transmissions to TRPs. The scheduling information may include at least one of the followings.
CORESETPoolIndex: CORESETPoolIndex may be mapped to PUSCH repetition transmissions to TRPs, and may be a value that belongs to a CORESET corresponding to scheduling DCI when PUSCH repetition transmissions are indicated by multi-DCI. When PUSCH repetition transmissions are indicated by single-DCI, a CORESETPoolIndex mapping method for each repetition transmission may be explicitly/implicitly indicated.
Frequency domain resource allocation (FDRA): Different frequency domain resource allocations may be respectively indicated for PUSCH repetition transmissions to TRPs, and the resource allocations may be explicitly indicated by DCI with respect to respective PUSCH repetition transmissions or may be determined according to a predefined pattern.
Time domain resource allocation (TDRA): Different time domain resource allocations may be respectively indicated for PUSCH repetition transmissions to TRPs, and the resource allocations may be explicitly indicated by DCI with respect to respective PUSCH repetition transmissions. Alternatively, when a total number of PUSCH repetition transmissions and a symbol length of each repetition transmission are set, mapping between a PUSCH and a TRP corresponding to a particular order may be determined.
MCS: Different MCSs may be indicated for respective PUSCH repetition transmissions to TRPs, and the MCSs may be explicitly indicated by DCI with respect to respective PUSCH repetition transmissions.
Transport block size (TBS): Different TBSs may be calculated by different resource/MCS allocations with respect to respective PUSCH repetition transmissions to TRPs.

The BS and the UE may select a parameter for each TRP or a combination of parameters, which indicate scheduling information, may calculate a TB size and an LDPC BG corresponding to a PUSCH to be transmitted, based on the selected parameter or the combination of parameters, and may apply the calculated TB size and LDPC BG to all PUSCH repetition transmissions. For example, when FDRAs with respect to respective PUSCH repetition transmissions to TRPs are different, the BS and the UE may calculate a TB size and an LDPC BG based on a PUSCH to which a smallest RB is allocated, and may apply the calculated TB size and LDPC BG to all PUSCH repetition transmissions. Alternatively, the BS and the UE may apply a smallest TB size to all PUSCH repetition transmissions, from among TB sizes with respect to respective PUSCH repetition transmissions to TRPs.

### Second-2 Embodiment: Method by which BS Performs Scheduling to Equally Match TB Sizes and LDPC BGs for Repetition Transmission PUSCHs

The BS may know in advance values of TB size and LDPC BG to be calculated by the UE, with respect to codeword being repeatedly transmitted to each TRP. As described above, a TB to be calculated by the UE may be obtained based on an intermediate number of information bits in a PDSCH (or, as an intermediate number of information bits), and each element of the intermediate number of information bits may be the same as described above. In order to allow the UE to have a same TB size with respect to codeword being transmitted to each TRP, the BS may configure a restriction on at least one of four elements of the intermediate number of information bits per TRP/codeword. For example, the BS may configure, as a restriction, a case where N_RE values are the same, a case where frequency and time-domain resource allocation information is the same, a case where MCSs are the same, or a case where the number of layers is the same, per TRP/codeword. Also, two or more of the restrictions above may be combined. Alternatively, even when the restrictions are not applied, a combination of N_RE, R, Q_m, v values may be configured to equalize a TB size to be calculated by the UE per TRP/codeword. The UE may not expect that a TB size calculated per TRP/codeword would vary.

The UE may calculate an LDPC BG based on a TB size calculated by the UE and a target code rate indicated by an MCS. The BS may configure restrictions on a TB size and/or an MCS so as to equalize an LDPC BG to be calculated by the UE per TRP/codeword. For example, in order to obtain a same TB size per TRP/codeword, the BS may configure the restrictions described above, and may configure restrictions to make an MCS equal. Even when the restrictions are not applied, a combination of a TB size and an MCS may be configured to allow the UE to identify a same LDPC BG per TRP/codeword. The UE may not expect that an LDPC BG calculated per TRP/codeword would vary.

The restrictions may be obtained by fixing different parameter values inducing the N_RE, R, Q_m, v values. For example, a restriction may be configured to equalize the number of RBs being allocated to all repetition transmissions, as a condition to equalize N_RE values for all repetition transmissions. Here, the number of RBs being allocated may be the number of RBs determined based on pathloss to a TRP with largest pathloss.

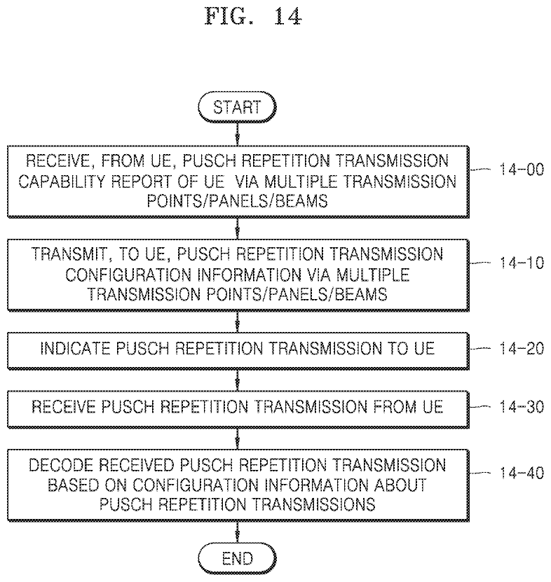

FIG. 14 is a flowchart illustrating BS operations in a wireless communication system according to an embodiment of the disclosure.

Referring to FIG. 14, a BS may identify PUSCH repetition transmission capability of a particular UE via multiple transmission points/panels/beams by receiving a UE capability report from the UE (14-00).

Next, the BS may configure the UE with PUSCH repetition transmissions via the multiple transmission points/panels/beams (14-10). The configuration of the PUSCH repetition transmissions via the multiple transmission points/panels/beams may be applied only to a UE having PUSCH repetition transmission capability. The BS may transmit configuration information about the PUSCH repetition transmissions to the UE. The configuration information may include a repetition transmission method described with reference to the second embodiment of the disclosure, e.g., a repetition transmission method using different spatial resources/a repetition transmission method using different frequency resources/a repetition transmission method using different time resources/or a combination of the methods, and the number of repetition transmissions. Also, the configuration information may include information about mapping between each PUSCH repetition transmission and each transmission point/panel/beam, which is described with reference to the second-1 embodiment of the disclosure. The information about mapping may include power allocation information for each PUSCH repetition transmission, beam information for each PUSCH repetition transmission, or the like. The configuration may be semi-statically configured by higher layer signaling such as RRC, or may be dynamically configured by DCI, MAC-CE, or the like. Alternatively, a part of the configuration may be configured by higher layer signaling and the rest may be dynamically configured.

Also, the configuration information about the PUSCH repetition transmissions via the multiple transmission points/panels/beams may include information about the restrictions described with reference to the second-2 embodiment of the disclosure. For example, the configuration information may include at least one information among information about an intermediate number of information bits in a PDSCH, restriction information about at least one of four elements of the intermediate number of information bits, or restriction information about a TB size and/or an MCS.

Next, the BS may indicate PUSCH repetition transmission to the UE (14-20). The PUSCH transmission indication may include indication of grant-based PUSCH transmission indicated by DCI, in correspondence to a scheduling request (SR) response, and/or indication of grant-free PUSCH transmission which is indicated by RRC or DCI and for which a PUSCH transmission resource is periodically allocated to the UE. The BS may transmit a control signal including the PUSCH repetition transmission indication to the UE. The control signal for the PUSCH transmission indication may include transmission resource allocation information for PUSCH transmission. Also, the control signal may include a part or all of the configuration information about the PUSCH repetition transmissions described in operation 14-10. For example, the information about mapping between each PUSCH repetition transmission and each transmission point/panel/beam may be included in the control signal, and the information about mapping may include power allocation information for each PUSCH repetition transmission, beam information for each PUSCH repetition transmission, or the like.

Next, after the BS receives the indicated PUSCH repetition transmission transmitted from the UE (14-30), the BS may decode the received PUSCH repetition transmission based on the configuration information about the PUSCH repetition transmissions described above in operation 14-40. The BS may decode all BS-received PUSCH repetition transmissions, by applying an LDPC BG and a TBS determined according to the second embodiment of the disclosure. For example, the BS may determine the LDPC BG and the TBS based on PUSCH repetition transmission parameters (transmission power value or its associated parameter, transmission beam/precoder, or scheduling information), according to the second-1 embodiment of the disclosure, and may determine the LDPC BG and the TBS based on the restrictions configured in associated with PUSCH repetition transmissions, according to the second-2 embodiment of the disclosure. The BS may decode the received PUSCH repetition transmission, based on the LDPC BG and the TBS. In order to improve decoding performance, the BS may perform, before decoding, combining between BS-received PUSCH repetition transmissions.

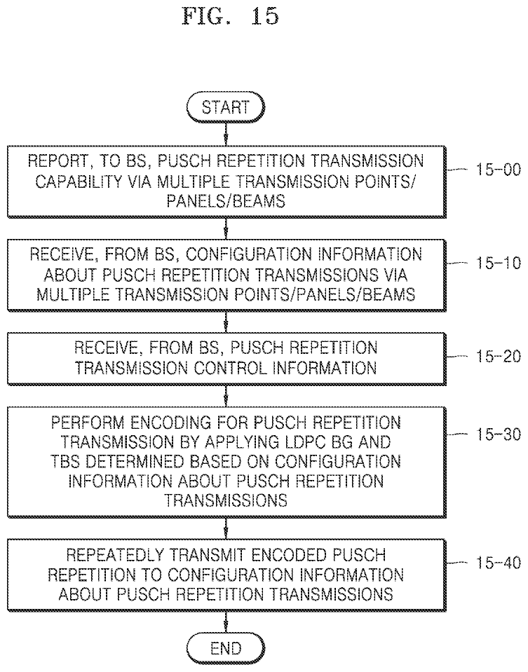

FIG. 15 is a flowchart illustrating UE operations in a wireless communication system according to an embodiment of the disclosure.

Referring to FIG. 15, a UE may transmit a UE capability report to a BS, and may include, in the UE capability report, PUSCH repetition transmission capability via multiple transmission points/panels/beams of the UE (15-00). If the UE does not have the PUSCH repetition transmission capability via multiple transmission points/panels/beams, the UE may report that the UE does not support the capability or may omit reporting on the capability.

Next, the UE may receive, from the BS, configuration information about PUSCH repetition transmissions via multiple transmission points/panels/beams (15-10). If the UE does not support the PUSCH repetition transmission capability via multiple transmission points/panels/beams, the UE may ignore the received configuration information about PUSCH repetition transmissions or may report reception of irrelevant configuration information to the BS. The configuration information about PUSCH repetition transmissions may include a repetition transmission method described with reference to the second embodiment of the disclosure, e.g., a repetition transmission method using different spatial resources/a repetition transmission method using different frequency resources/a repetition transmission method using different time resources/or a combination of the methods, and the number of repetition transmissions. Also, the configuration information may include information about mapping between each PUSCH repetition transmission and each transmission point/panel/beam, which is described with reference to the second-1 embodiment of the disclosure. The information about mapping may include power allocation information for each PUSCH repetition transmission, beam information for each PUSCH repetition transmission, or the like. The configuration may be semi-statically configured by higher layer signaling such as RRC, or may be dynamically configured by DCI, MAC-CE, or the like. Alternatively, a part of the configuration may be indicated by higher layer signaling and the rest may be dynamically indicated.

Also, the configuration information about the PUSCH repetition transmissions via the multiple transmission points/panels/beams may include information about the restrictions described with reference to the second-2 embodiment of the disclosure. For example, the configuration information may include at least one information among information about an intermediate number of information bits in a PDSCH, restriction information about at least one of four elements of the intermediate number of information bits, or restriction information about a TB size and/or an MCS.

Next, the UE may be indicated PUSCH repetition transmission (15-20). The PUSCH transmission indication may include indication of grant-based PUSCH transmission indicated by DCI from the BS in correspondence to a SR transmitted from the UE, and/or indication of grant-free PUSCH transmission which is indicated by RRC or DCI and for which a PUSCH transmission resource is periodically allocated to the UE. The UE may receive a control signal including the PUSCH repetition transmission indication from the BS. The control signal for the PUSCH transmission indication may include transmission resource allocation information for PUSCH transmission. Also, the control signal may include a part or all of the configuration information about the PUSCH repetition transmissions described in operation 15-10. For example, the information about mapping between each PUSCH repetition transmission and each transmission point/panel/beam may be included in the control signal, and the information about mapping may include power allocation information for each PUSCH repetition transmission, beam information for each PUSCH repetition transmission, or the like.

Next, the UE may perform encoding for the PUSCH repetition transmission, and here, the UE may apply an LDPC BG and a TBS determined based on the configuration information about the PUSCH repetition transmissions described above in operation 14-10 (15-30). The UE may determine the LDPC BG and the TBS according to the second embodiment of the disclosure. For example, the UE may determine the LDPC BG and the TBS based on PUSCH repetition transmission parameters (transmission power value or its associated parameter, transmission beam/precoder, or scheduling information), according to the second-1 embodiment of the disclosure, and may determine the LDPC BG and the TBS based on the restrictions configured in associated with PUSCH repetition transmissions, according to the second-2 embodiment of the disclosure. The UE may perform encoding for the PUSCH repetition transmission, based on the determined LDPC BG and TBS. The UE may repeatedly transmit the encoded PUSCH according to the indicated configuration information about the PUSCH repetition transmissions via the multiple transmission points/panels/beams (15-40).

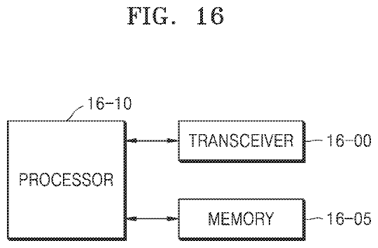

FIG. 16 is a diagram illustrating a structure of a UE in a wireless communication according to an embodiment of the disclosure.

Referring to FIG. 16, the UE may include a transceiver 16-00, a memory 16-05, and a processor 16-10. According to the communication method of the UE described above, the transceiver 16-00 and the UE processor 16-10 of the UE may operate. However, elements of the UE are not limited to the example above. For example, the UE may include more elements than those described above or may include fewer elements than those described above. In addition, the transceiver 16-00, the memory 16-05, and the processor 16-10 may be implemented as one chip.

The transceiver 16-00 may transmit or receive a signal to or from a BS. Here, the signal may include control information and data. To this end, the transceiver 16-00 may include a radio frequency (RF) transmitter for up-converting and amplifying a frequency of signals to be transmitted, and an RF receiver for low-noise-amplifying and down-converting a frequency of received signals. However, this is merely an example of the transceiver 16-00, and elements of the transceiver 16-00 are not limited to the RF transmitter and the RF receiver.

Also, the transceiver 16-00 may receive signals through wireless channels and output the signals to the processor 16-10, and may transmit signals output from the processor 16-10, through wireless channels.

The memory 16-05 may store programs and data required for the UE to operate. Also, the memory 16-05 may store control information or data included in a signal transmitted or received by the UE. The memory 16-05 may include any or a combination of storage media such as read-only memory (ROM), random access memory (RAM), a hard disk, a compact disc (CD)-ROM, a digital versatile disc (DVD), or the like. Also, the memory 16-05 may include a plurality of memories.

Also, the processor 16-10 may control a series of processes to allow the UE to operate according to the embodiments. For example, the processor 16-10 may control elements of the UE to receive DCI consisting of two layers so as to simultaneously receive a plurality of PDSCHs. The processor 16-10 may be provided in a multiple number, and may perform an element control operation of the UE by executing a program stored in the memory 16-05.

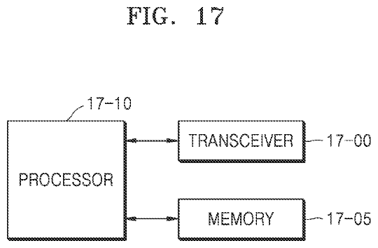

FIG. 17 is a diagram illustrating a structure of a BS in a wireless communication system according to an embodiment of the disclosure.

Referring to FIG. 17, the BS may include a transceiver 17-00, a memory 17-05, and a processor 17-10. According to the communication method of the BS described above, the transceiver 17-00 and the processor 17-10 of the BS may operate. However, elements of the BS are not limited to the example above. For example, the BS may include more elements than those described above or may include fewer elements than those described above. In addition, the transceiver 17-00, the memory 17-05, and the processor 17-10 may be implemented as one chip.

The transceiver 17-00 may transmit or receive a signal to or from a UE. Here, the signal may include control information and data. To this end, the transceiver 17-00 may include a RF transmitter for up-converting and amplifying a frequency of signals to be transmitted, and an RF receiver for low-noise-amplifying and down-converting a frequency of received signals. However, this is merely an example of the transceiver 17-00, and elements of the transceiver 17-00 are not limited to the RF transmitter and the RF receiver.

Also, the transceiver 17-00 may receive signals through wireless channels and output the signals to the processor 17-10, and may transmit signals output from the processor 17-10, through wireless channels.

The memory 17-05 may store programs and data required for the BS to operate. Also, the memory 17-05 may store control information or data included in a signal transmitted or received by the BS. The memory 17-05 may include any or a combination of storage media such as ROM, RAM, a hard disk, a CD-ROM, a DVD, or the like. Also, the memory 17-05 may include a plurality of memories.

Also, the processor 17-10 may control a series of processes to allow the BS to operate according to the embodiments of the disclosure. For example, the processor 17-10 may configure a plurality of pieces of DCI consisting of two layers and including allocation information associated with a plurality of PDSCHs, and may control each element to transmit the DCI. The processor 17-10 may be provided in a multiple number, and may perform an element control operation of the BS by executing a program stored in the memory 17-05.

The methods according to the embodiments of the disclosure as described in claims or specification may be implemented as hardware, software, or a combination of hardware and software.

When implemented as software, a computer-readable storage medium which stores one or more programs (e.g., software modules) may be provided. The one or more programs stored in the computer-readable storage medium are configured for execution by one or more processors in an electronic device. The one or more programs include instructions directing the electronic device to execute the methods according to the embodiments of the disclosure as described in the claims or the specification.

The programs (e.g., software modules or software) may be stored in non-volatile memory including random access memory (RAM) or flash memory, read only memory (ROM), electrically erasable programmable read only memory (EEPROM), a magnetic disc storage device, a compact disc (CD)-ROM, a digital versatile disc (DVD), another optical storage device, or a magnetic cassette. Alternatively, the programs may be stored in memory including a combination of some or all of the above-mentioned storage media. Also, a plurality of such memories may be included.

In addition, the programs may be stored in an attachable storage device accessible through any or a combination of communication networks such as Internet, an intranet, a local area network (LAN), a wide LAN (WLAN), a storage area network (SAN), or the like. Such a storage device may access, via an external port, a device performing the embodiments of the disclosure. Furthermore, a separate storage device on the communication network may access the electronic device performing the embodiments of the disclosure.

In the afore-described embodiments of the disclosure, elements included in the disclosure are expressed in a singular or plural form according to the embodiments of the disclosure. However, the singular or plural form is appropriately selected for convenience of explanation and the disclosure is not limited thereto. As such, an element expressed in a plural form may also be configured as a single element, and an element expressed in a singular form may also be configured as plural elements.

The embodiments of the disclosure described with reference to the present specification and the drawings are merely illustrative of specific examples to easily facilitate description and understanding of the disclosure, and are not intended to limit the scope of the disclosure. In other words, it will be apparent to one of ordinary skill in the art that other modifications based on the technical ideas of the disclosure are feasible. Also, the embodiments may be combined to be implemented, when required. For example, the BS and the UE may be operated in a manner that portions of an embodiment of the disclosure are combined with portions of another embodiment of the disclosure. For example, the BS and the UE may be operated in a manner that portions of a first embodiment of the disclosure are combined with portions of a second embodiment of the disclosure. Also, although the embodiments are described based on a FDD LTE system, modifications based on the technical scope of the embodiments may be applied to other communication systems such as a TDD LTE system, a 5G or NR system, or the like.

1. A user equipment (UE) for transmitting or receiving a signal in a wireless communication system, the UE comprising:
a transceiver; and
at least one processor configured to
receive, from a base station (BS), configuration information for repeatedly transmitting a physical uplink shared channel (PUSCH) to a plurality of transmission and reception points (TRPs),
determine at least one of a transport block size and a low-density parity-check base graph (LDPC BG) for repetition transmission of the PUSCH, based on the configuration information for repeatedly transmitting the PUSCH to the plurality of TRPs,
encode a plurality of PUSCHs to be repeatedly transmitted to the plurality of TRPs, based on at least one of the transport block size and the LDPC BG, and
transmit the plurality of encoded PUSCHs to the plurality of TRPs, respectively.

2. The UE of claim 1, wherein the at least one processor is further configured to
receive, from the BS, configuration information comprising information about a plurality of sounding reference signal (SRS) resource sets for transmission of an SRS to the plurality of TRPs, and
wherein the plurality of SRS resource sets
respectively correspond to different TRPs among the plurality of TRPs.

3. The UE of claim 1, wherein
the plurality of encoded PUSCHs are transmitted to the plurality of TRPs, and wherein at least one of a time resource, a frequency resource, or a spatial resource for the plurality of encoded PUSCHs differs.

4. The UE of claim 1, wherein the at least one processor is further configured to
determine representative information based on at least one of a plurality of pieces of configuration information respectively for the plurality of TRPs, from the configuration information for repeatedly transmitting the PUSCH to the plurality of the TRPs, and
determine, based on the representative information, at least one of the transport block size and the LDPC BG for repetition transmission of the PUSCH.

5. The UE of claim 4, wherein
the representative information is determined based on at least one of power information, transmission beam information, transmission precoder information, and scheduling information which are about each of the plurality of the TRPs.

6. The UE of claim 4, wherein
the representative information is determined based on, among the configuration information for repeatedly transmitting the PUSCH to the plurality of the TRPs, configuration information including a value that corresponds to one parameter or a combination of a plurality of parameters is a largest value or a smallest value or configuration information corresponding to a transmission point with a smallest index.

7. The UE of claim 1, wherein the at least one processor is further configured to
determine at least one of the transport block size and the LDPC BG for repetition transmission of the PUSCH, based on configuration information by which a first PUSCH is scheduled, among the configuration information for repeatedly transmitting the PUSCH to the plurality of the TRPs.

8. The UE of claim 1, wherein the at least one processor is further configured to
identify a plurality of pieces of configuration information respectively corresponding to the plurality of the TRPs, from the configuration information for repeatedly transmitting the PUSCH to the plurality of the TRPs,
determine a plurality of transport block sizes respectively corresponding to the plurality of the TRPs, from the plurality of pieces of identified configuration information,
identify a smallest transport block size among the plurality of transport block sizes, and
encode the plurality of PUSCHs to be repeatedly transmitted to the plurality of TRPs, based on the identified smallest transport block size.

9. The UE of claim 1, wherein the configuration information for repeatedly transmitting the PUSCH to the plurality of TRPs comprises
a restriction configured by the BS to equally match transport block sizes and LDPC BGs for the PUSCHs to be transmitted to the plurality of TRPs.

10. The UE of claim 9, wherein
the restriction indicates a case where at least one of a number of resource elements (REs), a code rate, a modulation order, and a number of layers is equal.

11. The UE of claim 1, wherein the configuration information for repeatedly transmitting the PUSCH to the plurality of TRPs comprises
one control information for scheduling all PUSCHs for the plurality of the TRPs or a plurality of pieces of control information for respectively scheduling PUSCHs for the plurality of the TRPs.

12. The UE of claim 1, wherein the at least one processor is further configured to
report, to the BS, a capability report on PUSCH repetition transmissions via the plurality of the TRPs, and
receive, from the BS, information indicating repetition transmission of the PUSCH, based on the capability report on the PUSCH repetition transmissions via the plurality of the TRPs.

13. The UE of claim 1, wherein the at least one processor is further configured to
identify a number of REs, a code rate, a modulation order, and a number of layers from the configuration information for repeatedly transmitting the PUSCH to the plurality of TRPs,
determine the transport block size, based on the number of REs, the code rate, the modulation order, and the number of layers, and
determine the LDPC BG, based on the determined transport block size.

14. A base station (BS) for transmitting or receiving a signal in a wireless communication system, the BS comprising:
a transceiver; and
at least one processor configured to
transmit, to a user equipment (UE), configuration information for repeatedly transmitting a physical uplink shared channel (PUSCH) to a plurality of transmission and reception points (TRPs),
receive a PUSCH being repeatedly transmitted from the UE,
determine at least one of a transport block size and a low-density parity-check base graph (LDPC BG), based on the configuration information for repeatedly transmitting the PUSCH to the plurality of TRPs, and
decode the received PUSCH being repeatedly transmitted, based on at least one of the transport block size and the LDPC BG.

15. An operating method of a user equipment (UE) for transmitting or receiving a signal in a wireless communication system, the operating method comprising:
receiving, from a base station (BS), configuration information for repeatedly transmitting a physical uplink shared channel (PUSCH) to a plurality of transmission and reception points (TRPs);
determining at least one of a transport block size and a low-density parity-check base graph (LDPC BG) for repetition transmission of the PUSCH, based on the configuration information for repeatedly transmitting the PUSCH to the plurality of TRPs;
encoding a plurality of PUSCHs to be repeatedly transmitted to the plurality of TRPs, based on at least one of the transport block size and the LDPC BG, and
transmitting the plurality of encoded PUSCHs to the plurality of TRPs, respectively.
